(19) United States
(12) Patent Application Publication
(10) Pub. No.: US 2006/0257306 A1
(43) Pub. Date: Nov. 16, 2006

(54) Nanoparticles of calcium phosphate compound, dispersion liquid thereof and method of production thereof

(75) Inventors: Akira Yamamoto, Tokyo (JP); Yusuke Iimori, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/430,989

(22) Filed: May 10, 2006

(30) Foreign Application Priority Data
May 10, 2005 (JP) 2005-136830

(51) Int. Cl. C01B 15/16

(52) U.S. Cl. 423/305

(57) ABSTRACT

Calcium phosphate compound nanoparticles includes high crystalline nanoparticles, wherein upon sustaining a thermal history, a crystallite diameter thereof at a maximum peak in an X-ray diffraction spectrum is in a range of 10 nm to 100 nm, and a shape of the high crystalline nanoparticles is one of spherical and oval-spherical.

### BACKGROUND OF THE INVENTION

1. Field of the Invention

The present invention relates to nanoparticles of calcium phosphate compound, dispersion liquid thereof and the method of their production.

2. Description of the Prior Art

The finely divided particle of which the diameter is not more than 1 μm is called a nanoparticle, because the particle size is expressed by a nanometer unit, and the atomization (nanoparticle formation) process of many kinds of materials is researched in various industrial fields.

The reason such research is being carried out is that the material that forms a nanoparticle shows an improvement of flowability, an increase in surface area and an enhancement of reactivity on the surface. By applying a change of such physical properties, an improvement in density at the time of compression molding, an increase in adsorption capacity, an improvement of a function as a chemical reaction catalyst, and the productivity of a composite with other materials can be achieved easily. The addition of the function of a nanoparticle to other materials is commonly achieved by mixing or forming a composite with other materials in the field of coatings, surface modification materials, cosmetics, high refraction index glasses, ceramics, strong magnetic materials and semiconductor materials, etc.

Accordingly, nanoparticle formation of substances is become extremely important technology, and in recent years, there have been high expectations in the application of nanoparticle technology in regard to, for example, development of particles having the size of several nm called quantum dots in the electric and electronic field; nano electronic devices in molecule/nanosize electronics, a microminiature tubes, and luminescent materials; coating compositions, surface treatments, film, coating optical material for media materials, high strength material, and gradient material used in high performance material development; high performance catalysts, miniaturization of chemical reactors, miniaturization and high sensitization of chemical analyzers in the field of chemical engineering; electrode materials, fuel cells in the field of energy development; and additionally, drug delivery systems and molecular handling in the field of medical care and development of new drugs.

Hydroxyapatite which is one of the materials that has high expectations in regard to nanoparticle formation is used, for example, in materials for orthopedics such as artificial prosthetic fillers, dental materials, adsorption materials for chromatography columns, catalysts, and fluorescent materials, etc. In regard to the utilization of hydroxyapatite in artificial prosthetic fillers and adsorbents, in recent years, attention has especially been focused on the development of reproduction medical treatment and biotechnology technology. Namely, by using hydroxyapatite nanoparticles for a bone filler, complexation with other materials, and a high-intensity and highly functional bone filler can be expected.

In addition, chromatographic analyzers have also advanced in regard to miniaturization, high speed and high sensitivity in accordance with more sophisticated chromatography technology, and hence, it is required that a column filler be made via nanoparticle formation. A column is filled with suitable filler depending on the target for analysis, and, for example, hydroxyapatite which is a kind of calcium phosphate compound is used as a column filler for protein analysis. Hydroxyapatite is used for adsorbing a water-soluble biopolymer such as protein. The column currently used for protein analysis has a cylinder size of about 1 mm in inner diameter and several centimeters in length filled with particles of a diameter of 1 to 3 μm (J Biomed Mater Res Vol. 26, No. 8, Page 1053-1064 (1992)).

Generally, the separating efficiency of liquid chromatography analysis depends on the homogeneity of mass transfer within the column. Therefore, the density and the shape of the filled particles of filled particles in a column are made uniform, and the particle size is reduced to provide a column which has a high separating efficiency. Therefore, if hydroxyapatite having spherical nanoparticles is filled in the column, a highly precise protein chromatography can be performed, the precision of protein separating analysis can be improved drastically, and it can be expected that the time required for analysis is reduced.

However, since there are no nanoparticles of homogeneous hydroxyapatite, no column-shaped container available for filling such nanoparticles, and no filter for attaching to an inlet and outlet of the column, etc., the above-mentioned chromatographic column cannot currently be achieved.

Furthermore, the application of hydroxyapatite to drug delivery systems is regarded as an important along with other recent developments in molecular biology and advanced medical care, because it has excellent absorptivity and no biologically harmful contaminants, and has been practically used as implants.

When hydroxyapatite nanoparticles are used for the above-described applications, it is especially necessary for the particles to have crystallinity and the form of particle shape to be as uniform as possible. In the case where the particles are filled into a narrow chromatographic column, the spherical, uniform particles can attain a more uniform filling, the particles with crystallinity have high mechanical strength, and the resistance to pressure of the filled particles improves. In addition, in the case where hydroxyapatite nanoparticles are used as a carrier of a medicine, and in the case where the nanoparticles are mixed with other materials, it is important that the particles have chemical stability. Generally the hydroxyapatite particles that have advanced crystallization (i.e., having high chemical stability) can be obtained by heating. The particles obtained thereby are chemically stable in comparison with non-heated hydroxyapatite particles synthesized in an aqueous solution. Furthermore, by using spherical nanoparticles as a sinter material, it is expected that the sintered body can be strengthened (Mater Des Vol. 25, No. 6, Page 515-519 (2004. 09)).

There are many reports on processes for producing finely divided particles of hydroxyapatite, for example, by the so-called ‘wet process’ (Ceramics Association magazine Vol. 86, No. 990, Page 72-76 (1978)) in which the particles can be synthesized by reacting calcium ion and phosphate ion in an aqueous solution so that the ratio of Ca/P is 1.67, or by an emulsion process. In the emulsion process, the hydroxyapatite synthetic method in which reversed micell is produced in a oil phase by using a surface-active agent and then the phosphate ion and the calcium ion are reacted in a water phase in the micell is known in the art (Shintaro, Nakashima et. al, Japan Ceramics Association Autumn Symposium pre-literature Vol. 12, Page 37 (1999)), and the process of suppression of crystalline growth to the c-axis direction by controlling the their concentration when a phosphate ion and a calcium ion are reacted in an aqueous solution is known in the art (Kazuaki, Hashimoto et. al, Inorganic Material Vol. 3, Jan. Page. 30-38 (1996)).

However, hydroxyapatite nanoparticles synthesized by the wet process are in a crystal form of a needle or a column, have many lattice defects, and the mechanical strength thereof is low. In addition, since hydroxyapatite nanoparticles synthesized by the wet process are chemically unstable, include a lot of crystallization water, and have a needle crystal form, the crystalline particles have a tendency to grow up in a longitudinal direction, and it is difficult to classify the particles by their size because of their high cohesion.

The hydroxyapatite nanoparticles synthesized in reversed micell by an emulsion process include many contaminants such as a surface-active agent and an oil phase ingredient. Therefore, when trying to attain crystalline particles, it is necessary to completely remove the contaminants, and an oxidative destruction process of organic components is needed; accordingly, the production procedures are very complicated. In the process for changing the ion concentrations in the liquid phase, it is difficult to control the shape of the hydroxyapatite particles, and the particle size of the spherical particles obtained is a few microns.

Incidentally, the defectiveness of a crystal and the activity of a particle surface are desirable properties in the case of attaining an adsorption agent or a surface reaction. However, there are some problems from a view point of stably dispersing particles, or stopping the crystalline growth of the particles to retain the size thereof. Hydroxyapatite is an ionic crystal, and ions exposed to the crystal surface are recombined easily with other crystals, which is the problem concerning the utilization the particles themselves, as described above. It is important, in the industrial field using the hydroxyapatite nanoparticles mentioned above, that the hydroxyapatite nanoparticles which have a high dispersibility and a moderately low surface chemical potential are simultaneously provided.

Although the needle-like hydroxyapatite crystals aggregate so that the major axis of each other overlap, it is considered that the aggregate form minimizes the surface area. Furthermore, the high surface chemical potential is considered to be due to the lattice defects which constitute a crystal and an ion electrical charge imbalance. Accordingly, it is predicted that the above-mentioned problems can be solved by producing the hydroxyapatite nanoparticles which are crystalline and are spherical shaped.

### SUMMARY OF THE INVENTION

The present invention provides spherical or oval-spherical nanoparticles which contain no contaminants, dispersion liquid thereof, and the method of producing a large amount thereof efficiently at a low cost.

The present invention has be devised based on the finding that it is possible to recover spherical or oval-spherical nanoparticles in a pure state by heat-treating finely divided aggregate particles of a calcium phosphate compound to improve the crystallinity, and thereafter eliminating and dispersing the finely divided particles, which adhere to and remain in the aggregate and do not grain grow, by mechanical stimulation such as an ultrasonic wave from a surface of the aggregate.

According to an aspect of the present invention, calcium phosphate compound nanoparticles are provided, including crystalline nanoparticles, wherein upon sustaining a thermal history, a crystallite diameter thereof at a maximum peak in an X-ray diffraction spectrum is in a range of 10 nm to 100 nm, and a shape of the crystalline nanoparticles is one of spherical and oval-spherical.

It is desirable for a mean aspect ratio of the calcium phosphate compound nanoparticles to be in a range of 1.0 to 2.5.

It is desirable for the thermal history to consist of heat-treatment at a temperature of 400° C. to 1050° C.

It is desirable for the calcium phosphate compound nanoparticles to be dispersed in an organic solvent.

It is desirable for the organic solvent to be a polar organic solvent.

It is desirable for the polar organic solvent to be at least one of alcohol, ether, acetonitrile, tetrahydrofuran, and dimethylsulphoxide.

In an embodiment, a production method of a dispersion liquid of calcium phosphate compound nanoparticles is provided, including a thermal treating process of heating a calcium phosphate compound; a crushing process of dispersing the calcium phosphate compound particles obtained in the thermal treating process in an organic solvent and crushing the calcium phosphate compound particles; and a separating process of centrifuging the dispersion liquid of calcium phosphate compound obtained in the crushing process and collecting a supernatant liquid thereof.

It is desirable for the production method of a dispersion liquid of calcium phosphate compound nanoparticles to include a milling process, wherein the calcium phosphate compound particles obtained in the thermal treating process are ball milled.

The ball milling can be performed in a ball mill without using balls.

The ball milling can be performed under dry conditions.

It is desirable for the calcium phosphate compound to include hydroxyapatite as a starting material, and wherein the hydroxyapatite is granulated by spray-drying.

It is desirable for the thermal treatment process to be performed at a temperature of 400° C. to 1050° C.

It is desirable for the organic solvent to be a polar organic solvent.

It is desirable for the polar organic solvent to be at least one of alcohol, ether, acetonitrile, tetrahydrofuran, and dimethylsulphoxide.

It is desirable for the crushing process to be performed by ultrasonication.

In an embodiment, a production method of calcium phosphate compound nanoparticles, is provided, including evaporating the organic solvent in the supernatant liquid obtained in the separating process.

According to the present invention, calcium phosphate compound nanoparticles are provided, having a particle size in nanometer units, and are in a uniform shape within a range of a spherical or an oval-spherical shape, which include no contaminants and are crystalline and have high mechanical strength by having a thermal history. Additionally, the calcium phosphate compound nanoparticles according to the present invention have few lattice defects on the surface thereof, so that particle agglutination that reduces lattice defects does not occur easily. Furthermore, the calcium phosphate compound nanoparticles according to the present invention have high dispersibility because their contacting face is small compared with a needle-like crystal when the particles come into contact, and are stable to heat as compared with the particles synthesized only by a wet process because the crystallinity increase by heat.

Furthermore, a remarkably improved yield of nanoparticles is achieved by performing a grinding method using a ball mill before crushing such as ultrasonication, according to the present invention. Furthermore, according to the present invention, the dispersion liquid of calcium phosphate compound nanoparticles as mentioned above can be obtained efficiently, in large quantities, easily and at a low cost.

The present disclosure relates to subject matter contained in Japanese Patent Application No. 2005-136830 (filed on May 10, 2005) which is expressly incorporated herein by reference in its entirety.

### BRIEF DESCRIPTION OF THE DRAWINGS

The present invention will be described below in detail with reference to the accompanying drawings in which:

FIG. 1 is a scanning electron microphotograph of the thermally treated hydroxyapatite particles prepared in Example 1;

FIG. 2 is a laser diffraction particle size distribution diagram of the thermally treated hydroxyapatite particles prepared in Example 1 before ultrasonication;

FIG. 3 is a laser diffraction particle size distribution diagram of the thermally treated hydroxyapatite particles prepared in Example 1 after ultrasonication;

FIG. 4 is a particle size distribution diagram by the dynamic scattering method of the dispersion liquid of the thermally treated hydroxyapatite nanoparticles prepared in Example 1;

FIGS. 5A and 5B show the scanning electron microphotographs of the hydroxyapatite nanoparticles prepared in Example 1;

FIG. 6 shows X-ray diffraction spectra of the thermally treated hydroxyapatite particles prepared in Example 1 (A) before ultrasonication and (B) after ultrasonication, respectively;

FIG. 7 is a scanning electron microphotograph of the thermally treated hydroxyapatite particles prepared in Example 2;

FIG. 8 is a laser diffraction particle size distribution graph of the thermally treated hydroxyapatite particles prepared in Example 2 before ultrasonication;

FIG. 9 is a laser diffraction particle size distribution graph of the thermally treated hydroxyapatite particles prepared in Example 2 after ultrasonication;

FIG. 10 is a particle size distribution graph by the dynamic scattering process of the hydroxyapatite nanoparticles prepared in Example 2;

FIGS. 11A and 11B show the transmission electron microphotograph of the hydroxyapatite nanoparticles prepared in Example 2;

FIG. 12 shows X-ray diffraction spectra of the thermally treated hydroxyapatite particles prepared in Example 2 (A) before ultrasonication and (B) after ultrasonication;

FIG. 13 is a transmission electron microphotograph for measuring electron density of the hydroxyapatite nanoparticles prepared in Example 2;

FIG. 14 is a scanning electron microphotograph of the thermally treated hydroxyapatite particles prepared in Example 3;

FIG. 15 is a laser diffraction particle size distribution graph of the thermally treated hydroxyapatite particles prepared in Example 3 before ultrasonication;

FIG. 16 is a laser diffraction particle size distribution graph of the thermally treated hydroxyapatite particles prepared in Example 3 after ultrasonication;

FIG. 17 is a particle size distribution graph by the dynamic scattering process of the hydroxyapatite nanoparticles dispersion liquid prepared in Example 3;

FIGS. 18A and 18B are the transmission electron microphotographs of the hydroxyapatite nanoparticles prepared in Example 3;

FIG. 19 is X-ray diffraction spectra of the thermally treated hydroxyapatite particles prepared in Example 3 (A) before ultrasonic treating and (B) after ultrasonic treating;

FIG. 20 is a scanning electron microphotograph of the thermally treated hydroxyapatite particles prepared in Example 4;

FIG. 21 is a laser diffraction particle size distribution graph of the thermally treated hydroxyapatite particles prepared in Example 4 before dry mill treatment;

FIG. 22 is a Figure showing a relationship between the dry mill treatment time and the 50% average particle size of the thermally treated hydroxyapatite particles prepared in Example 4;

FIG. 23 are the transmission electron microphotograph of the hydroxyapatite nanoparticles prepared in Example 4;

FIG. 24 shows the relationship between the dry mill treatment time and the weight concentration of the hydroxyapatite nanoparticles prepared in Example 4;

FIG. 25 shows a relationship between the dry mill treated sample amounts and the 50% of the mean particle size of the thermally treated hydroxyapatite particles prepared in Example 4;

FIG. 26 shows a relationship between the dry mill treated sample amounts of the thermally treated hydroxyapatite particles and the weight concentration of the hydroxyapatite nanoparticles prepared in Example 4;

FIG. 27 is a scanning electron microphotograph of the thermally treated hydroxyapatite particles prepared in Example 5;

FIG. 28 shows a relationship between the dry mill treated sample amounts and the 50% of the mean particle size of the thermally treated hydroxyapatite particles prepared in Example 5;

FIG. 29 is the transmission electron microphotograph of the hydroxyapatite nanoparticles prepared in Example 5;

FIG. 30 shows a relationship between the dry mill treated sample amounts of the thermally treated hydroxyapatite particles and the weight concentration of the hydroxyapatite nanoparticles prepared in Example 5;

FIG. 31 is a Figure showing a relationship between the dry mill treated sample amounts and the 50% average particle size of the thermally treated hydroxyapatite particles prepared in Example 5;

FIG. 32 shows a relationship between the dry mill treated sample amounts of the thermally treated hydroxyapatite particles and the weight concentration of the hydroxyapatite nanoparticles prepared in Example 5;

FIG. 33 is a scanning electron microphotograph of the inner wall of the pot for dry mill treatment that is used for milling treating, without using balls, measured in Reference example 1;

FIG. 34 is a scanning electron microphotograph of the inner wall of the pot for dry mill treatment using the pot containing balls measured in Reference example 1;

FIG. 35 is a Figure showing that chemical compositions by EDX of finely divided particles obtained from dry mill treatment in the presence of balls measured in Reference example 1;

FIG. 36 is a graph showing (A) the 50% average particle size of the thermally treated hydroxyapatite particles prepared in Example 6 with the average particle size of 10 μm before dry mill treatment and after dry mill treatment, and (B) the 50% average particle size of the thermally treated hydroxyapatite particles with an average particle size of 4 μm;

FIGS. 37A and 37B show transmission electron microphotographs of the hydroxyapatite nanoparticles prepared in Example 6;

FIG. 38 is a graph showing (A) a measurement result of weight concentration of the hydroxyapatite nanoparticles prepared in Example 6, and (B) a measurement result of weight concentration of the hydroxyapatite nanoparticles made from the thermally treated hydroxyapatite particles with an average particle size of 4 μm;

FIGS. 39A, 39B, 39C and 39D are transmission electron microphotographs of each hydroxyapatite nanoparticle prepared in Example 7 with thermal treating temperature of 400° C., 700° C., 900° C. and 950° C. respectively;

FIG. 40 is a graph showing the relationship between the thermal treating temperature and the aspect ratio of the hydroxyapatite nanoparticles prepared in Example 7;

FIG. 41 is a graph showing the relationship between the thermal treating temperature and the crystallite diameter of the hydroxyapatite nanoparticles prepared in Example 7;

FIG. 42 is a graph showing the relationship between the thermal treating temperature and the weight concentration of the hydroxyapatite nanoparticles prepared in Example 7;

FIG. 43 is a transmission electron microphotograph of the hydroxyapatite nanoparticles prepared in Reference example 2;

FIG. 44 is a graph showing (A) the 50% average particle size of the thermally treated hydroxyapatite particles prepared in Example 8 before ultrasonic treating, (B) the 50% average particle size of the thermally treated hydroxyapatite particles when dry mill treatment is performed for 1 hour in Example 5, and (C) the 50% average particle size of the thermally treated hydroxyapatite particles prepared in Example 8 after ultrasonic treating;

FIG. 45 is a graph showing (A) the weight concentration of the hydroxyapatite nanoparticles measured in Example 5, and (B) the weight concentration of the hydroxyapatite nanoparticles measured in Example 8;

FIG. 46 is a graph of particle size distribution by a dynamic scattering method of the dispersion liquid wherein the hydroxyapatite nanoparticles prepared in Example 1 is dispersed in isopropanol;

FIG. 47 is a graph of particle size distribution by a dynamic scattering method of the dispersion liquid wherein the hydroxyapatite nanoparticles prepared in Example 1 is dispersed in dimethylsulphoxide;

FIG. 48 is a particle size distribution graph by a dynamic scattering method of the dispersion liquid wherein the hydroxyapatite nanoparticles prepared in Example 1 is dispersed in dimethylformamide;

FIGS. 49A and 49B are transmission electron microphotographs of 15000 times and 50000 times of the dispersion liquid, respectively, wherein hydroxyapatite nanoparticles prepared in Example 1 is dispersed in isopropanol;

FIGS. 50A and 50B are transmission electron microphotographs of 15000 times and 50000 times of the dispersion liquid, respectively, wherein hydroxyapatite nanoparticles prepared in Example 1 is dispersed in dimethylsulphoxide;

FIGS. 51A and 51B are transmission electron microphotographs of 15000 times and 50000 times of the dispersion fliud, wherein hydroxyapatite nanoparticles prepared in Example 1 is dispersed in dimethylformamide;

FIG. 52 is a transmission electron microphotograph of hydroxyapatite slurry prepared in Comparison Example 1;

FIG. 53 shows infrared absorption spectra of (A) hydroxyapatite nanoparticles prepared by emulsion process in Comparison Example 2, (B) hydroxyapatite crystallite prepared by wet process in Comparison Example 1, and (C) the surface active agent, respectively;

FIG. 54 is an enlarged portion of FIG. 53 in the vicinity of 2900 cm⁻¹; and

FIG. 55 shows X-ray diffraction spectra (A) to (C) of hydroxyapatite nanoparticles prepared in Example 1 to 3, respectively, and (D) hydroxyapatite nanoparticles prepared in Comparison Example 2.

### DESCRIPTION OF THE PREFERRED EMBODIMENT

A calcium phosphate compound in the present invention can be a compound such that the Ca/P ratio is 1.0 to 2.0, for example, various kinds of apatites such as hydroxyapatite, fluoroapatite, monobasic calcium phosphate, dibasic calcium phosphate, tribasic calcium phosphate or tetrabasic calcium phosphate, and they can be used alone or as a mixture thereof.

A calcium phosphate compound can be produced by a known process, for example, a calcium salt can be mixed with a phosphate at a ratio of Ca/P so as to become a chemical stoichiometric amount to react with Ca²⁺ and PO₄³⁻. Calcium chloride, calcium nitrate, and calcium hydroxide can be use as a calcium salt (Ca²⁺ source). Phosphoric acid, ammonium phosphate, sodium phosphate or potassium phosphate can be used as a phosphate (PO₄³⁻ source).

The calcium phosphate compound synthesized in this way is in the form of column-like, plate-like or needle-like particles, or an agglomerate thereof. In addition, this calcium phosphate compound usually has a low crystallinity of particles and the dynamic intensity is also usually weak.

The calcium phosphate compound according to the present invention sustains a thermal history, crystallinity and improved dynamic intensity, a crystallite diameter at the maximum peak in an X-ray diffraction pattern is 10 to 100 nm, and the shape thereof is spherical or oval-spherical. When the crystallite diameter is less than 10 nm, the crystallinity is too low, and as a result, sufficient particle strength, heat stability and chemical stability are not obtained, and when the crystallite diameter is more than 100 nm, it is difficult to obtain uniform particles in the calcium phosphate compound.

A crystallite diameter is a size of crystal obtained from a peak of an X-ray diffraction spectrum, and is calculated by the following condition (1):
t=λ/(β cos θ) (1)

wherein t represents crystallite size (Å), λ represents the X ray wavelength measured, β represents a half-band width (rad), and θ represents an incidence angle.

It is desirable for the mean of an aspect ratio (c-axial length/a-axial length) of the calcium phosphate compound nanoparticles to be in the range of 1.0 to 2.5.

It is undesirable for the particles to exceed the upper limit because the particle shape becomes needle-like or column-like. When an aspect ratio is a value close to 1.0, the particle shape is nearly spherical. If the particle shape is spherical, for example, when such a particle is used as a column filler for liquid chromatography, the accuracy of protein separation analysis is improved remarkably and the particle is suitable for shortening the time required for the analysis. Furthermore, it is of great significance that the particle shape is spherical for improvement of pressure molding density, coating to the surface of substance, and improvement of fluidity in a tube line.

The method for producing a dispersion liquid of calcium phosphate compound nanoparticles will be explained hereinafter in detail. It is desirable for the calcium phosphate compound used as a starting material be synthesized by a known process, dried before heat treating, and if necessary granulated. The granulation process can be performed by a well-known process, but desirably by a spray-dry process. In the spray-dry process, dried and granulated aggregation particles have high porosity, and therefore, porous particles having a volume ratio of more than 70% can be provided easily and in large quantities. The porous particles (porous body) provided in this way can adjust the grade of sintering easily in the thermal-treatment process, and since the granulated powder are spherical aggregates, it works well in industrial applications.

In the method of the present invention, the calcium phosphate compound is thermally treated so that the calcium phosphate compound sustains a thermal history. The thermal treatment can be performed by a well-known heating procedure. The heating temperature is not restricted, however, it is desirable for the heating process to be performed at a temperature of 400° C. to 1050° C. When the temperature of the heating process is lower than 400° C., a compound having enough strength can not be obtained and the use strength deteriorates. When the temperature of the heating process is higher than 1050° C., a part or all of the compound is sintered, and the yield of the nanoparticles deteriorates. Therefore in the present invention, it is important for the thermal treatment temperature to be controlled. Specifically, in order to obtain a spherical particle with a low aspect ratio, it is desirable that the temperature of the thermal treatment is near to a sinter temperature, and it is desirable that the thermal treatment temperature is lowered in order to obtain nanoparticles with a high yield. It is more desirable that the thermal treatment is performed at a temperature range of 850° C. to 1000° C. by considering the yield and the aspect ratio. Furthermore, it is more desirable from the point of the yield of the nanoparticles that the thermally treated particle is porous rather than being dense.

In the crushing process, the calcium phosphate compound obtained from the thermal treatment process is dispersed in an organic solvent, and nanoparticles without grain growth is dispersed in an organic solvent. With regard to an organic solvent, a polar organic solvent is desirable, for example alcohol (such as ethanol, isopropanol), ether (such as 2-ethoxyethanol), acetonitrile, tetrahydrofuran, and dimethylsulphoxide. The crushing device used for the crushing process can be, for example, an ultrasonic device, a homogenizer, a shaking apparatus, or a mortar, etc.

Furthermore, a milling process can be conducted before a crushing process and after a thermal treatment process. The milling process is conducted by treating the calcium phosphate compound particles in a ball mill apparatus. Generally, the ball mill treatment in a ball mill apparatus is performed by holding balls that crush the sample material with a grinding movement in the pot (ball mill) of the ball mill apparatus. However, in the present invention, it is desirable that the ball mill treatment is performed without using balls. When the milling process is performed in this way, nanoparticles which are more spherical (an aspect ratio thereof is almost 1) with a high yield can be obtained due to the effect of grinding between the calcium phosphate particles. In addition, it is desirable that the ball mill treatment is performed in a dry condition (referred to as dry mill treatment hereinafter) without any organic solvent added in the pot, i.e., calcium phosphate particles are only added in the pot.

In the separation process, the dispersion liquid of the calcium phosphate particles obtained from the crushing process is centrifuged. Namely, in the separation process, the supernatant liquid containing calcium phosphate compound dispersed in an organic solvent layer by the crushing process and the precipitates consisting of particles with a bigger diameter are fractionated. Although there are no particular restrictions on conditions of centrifugal separation, the particle size of calcium phosphate compound can be controlled by such conditions. Namely, when centrifugal force by centrifuging is enlarged, the nanoparticles having small particle size are contained in the supernatant layer, and when centrifugal force is made small, particles with a comparatively large particle size are contained in the supernatant layer. The supernatant obtained by such method is a dispersion liquid of the calcium phosphate compound nanoparticles.

In addition, in the present invention, depending on the use of the calcium phosphate compound nanoparticles, a drying process can be carried out as appropriate. In other words, the dispersion liquid of the calcium phosphate compound nanoparticles obtained in the above separation process may be used directly depending on the subsequent use, or the calcium phosphate compound nanoparticles may be obtained by evaporating an organic solvent in a drying process. The evaporation can be performed by a conventional method.

The invention will be further described in detail with reference to the following examples, however, the present invention is not restricted thereto.

Note that thermally treated hydroxyapatite particles (hereinafter called thermally treated HA particles) and hydroxyapatite nanoparticles (hereinafter called HA nanoparticles) obtained in the following embodiment examples and the comparative examples are used in various analysis by the following methods, unless not be mentioned specifically.

(A) Surface Structure and Average Particle Diameter

To observe the surface structure of the thermally treated HA particles and an average particle diameter of primary particles constituting the thermally treated HA particles, a scanning electron microscope (SEM) was used. The primary particles were crushed from the thermally treated HA particles by the milling process and/or the crushing process to provide HA nanoparticles. The thermally treated HA particles were placed on the sample stand of the scanning electron microscope, and the thermally treated HA particles were deposited with platinum-palladium, and then observed. The scanning electron microscope used was S-3000N and S-4300 made by Hitachi, Ltd., JAPAN

(B) Particle Size Distribution

In regard to the thermally treated HA particle dispersion liquid, the particle size distributions were measured before ultrasonication and after ultrasonication. For measurement of these particle size distributions, laser diffraction particle size distribution measurement equipment LS13320 made by Beckman-Coulter, Ltd., JAPAN, was used. Furthermore, the particle size was measured for the HA nanoparticle dispersion liquid. The measurement of the particle size distribution was performed by using Submicron Particle Size Analyzer N5 made by Beckman-Coulter, Ltd., JAPAN, via the dynamic scattering method. The results were measured three times (the first: rept. 1 (blue line), the second: rept. 2 (red line), the third: rept. 3 (green line) as shown in each example).

(C) Nanoparticle Shape and Aspect Ratio Thereof

The shapes of HA nanoparticles were observed by the HA nanoparticle dispersion liquid with a transmittance electron microscope (TEM), and the aspect ratio was calculated based on the photographs (observation images). At the same time, the existence ratio of the particles with an aspect ratio of less than 2 to the particles with an aspect ratio of 2 and more was calculated for HA nanoparticles in this dispersion liquid. The transmittance electron microscope was H-7600 made by Hitachi, Ltd., JAPAN.

(D) Crystalline Phase

The crystalline phase was measured for thermally treated HA particle dispersion liquids before and after ultrasonication. The measurement was performed with an X-ray diffraction device (XRD) RINT-Ultima III made by RIGAKU, Ltd., JAPAN. Furthermore, the samples were dried before measuring the crystalline phase.

(E) Weight Concentration Measurement

HA nanoparticles in the HA nanoparticle dispersion liquid were dissolved in nitric acid, the concentration of calcium ion was measured by using a cation analyzer column (Made by SHIMAZU Corporation, JAPAN; IC-C1) in an electrical conductivity detection machine (Made by SHIMAZU Corporation, JAPAN; CDD-10AVP). The weight concentration of HA nanoparticles was calculated from the obtained calcium cation concentration.

### EXAMPLE 1

An aqueous solution of a phosphate and an aqueous solution of a calcium salt were mixed to provide a slurry containing hydroxyapatite. The slurry containing hydroxyapatite was dried with spray-dry equipment at a temperature of 200° C. and then granulated. Thereafter, the granulated particles were classified to provide those having a average particle size of 20 μm. The obtained hydroxyapatite particles were placed into an electric oven and then thermally treated. The thermal treatment was performed by raising the temperature at the rate of 50° C./hr to 400° C. and then maintaining the temperature at 400° C. for 4 hours. 0.5 g of hydroxyapatite particles (thermally treated HA particles) were dispersed in 3 ml of isopropanol, and thereafter treated with ultrasonic wave (for 10 min at output 60 W) using an ultrasonic generator (TAITEC Inc., JAPAN; VP-30S). Thereafter, a total amount of 10 ml of isopropanol was added, and was centrifuged at 4100×g for 10 minutes. The supernatant layer after centrifuging, i.e., a dispersion liquid of hydroxyapatite nanoparticles (HA nanoparticles), was collected.

The results of various analysis of the thermally treated HA particles and HA nanoparticles obtained from this example is shown as follows.

(A) Particle Surface Structure and Average Particle Size

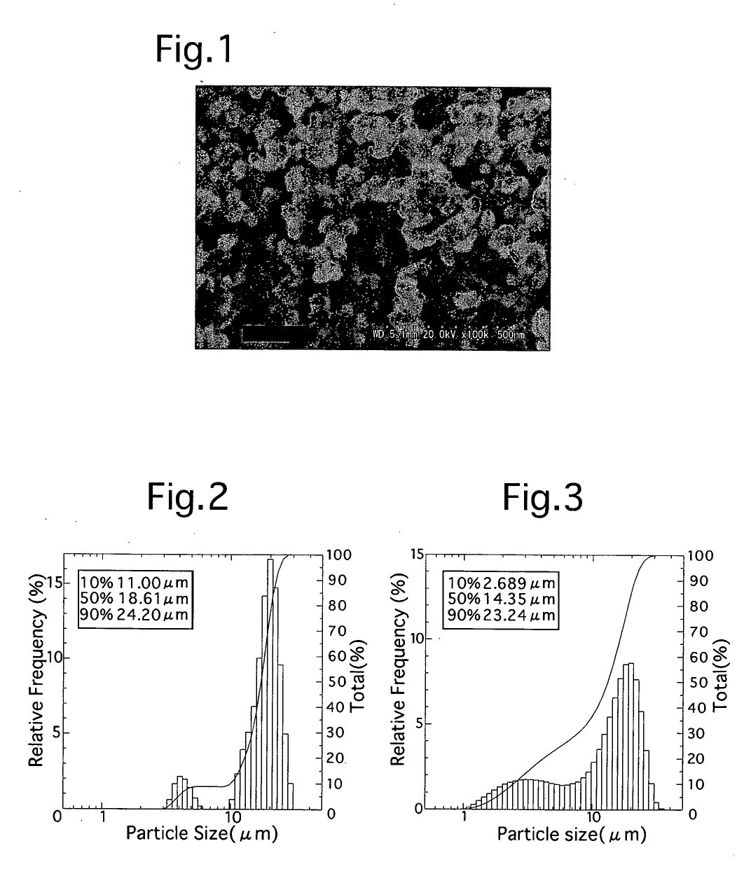

FIG. 1 shows a scanning electron microphotograph of the thermally treated HA particles prepared in this example. As observed in FIG. 1, the thermally treated HA particles are not sintered completely even by thermal treatment. The primary particles which were spherical and oval-spherical have bonded to the surface of the particles. The average particle size of the primary particles of thermally treated HA particles is about 100 nm according to FIG. 1. The microphotograph (observation) magnification is 100,000 times.

(B) Particle Size Distribution

FIG. 2 shows a laser diffraction particle size distribution of the thermally treated HA particles before ultrasonication. The average particle size of 50% of the thermally treated HA particles before ultrasonication was 19 μm, and the proportion of particles with a particle size of not more than 10 μm was about 10%, which is very few.

FIG. 3 shows a laser diffraction particle size distribution of the thermally treated HA particles before ultrasonication. The average particle size of 50% of the thermally treated HA particles before ultrasonication was reduced to 14 μm, and the proportion of particles with a particle size of not more than 10 μm was about 30%, the proportion increasing remarkably. Thus, the ultrasonication showed an efficient crushing effect.

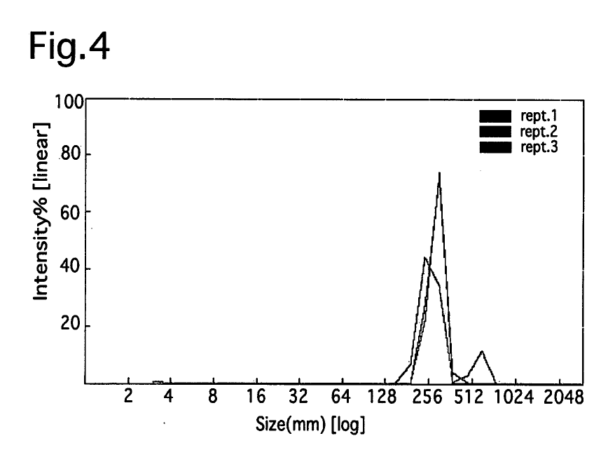

FIG. 4 shows a particle size distribution by a dynamic scattering method, and a average particle size of HA nanoparticles in the dispersion liquid was about 280 nm.

(C) Particle Shape and Aspect Ratio

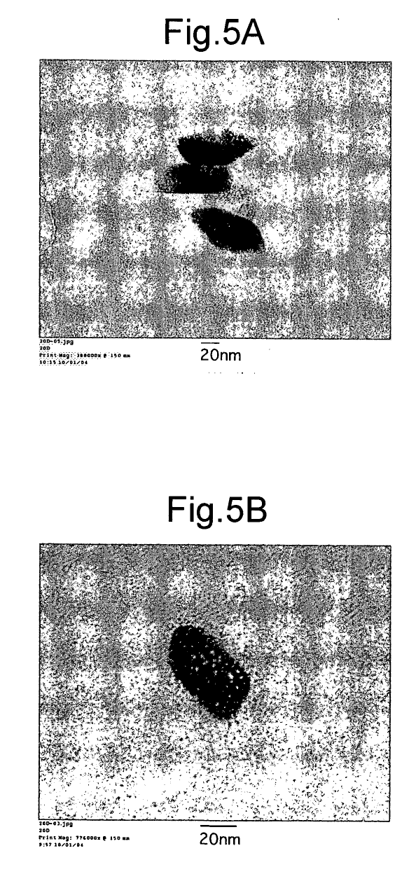

FIG. 5A and FIG. 5B show a scanning electron microphotograph of each thermally treated HA nanoparticles, respectively. Upon calculating the average particle size based on FIGS. 5A and 5B, the average particle size was about 41 nm, the average particle size of long axis was 40 nm, and the average particle size of short axis was about 25 nm. HA nanoparticles of this example were spherical or oval-spherical.

The aspect ratio was 1.2 to 2.7, and the mean of aspect ratio was 1.7. An existence ratio of the particles with an aspect ratio of less than 2 to the particles with an aspect ratio of 2 and more was 1:3. The microphotograph magnification was 60,000 times in FIG. 5A and 120,000 times in FIG. 5B.

(D) Crystalline Phase

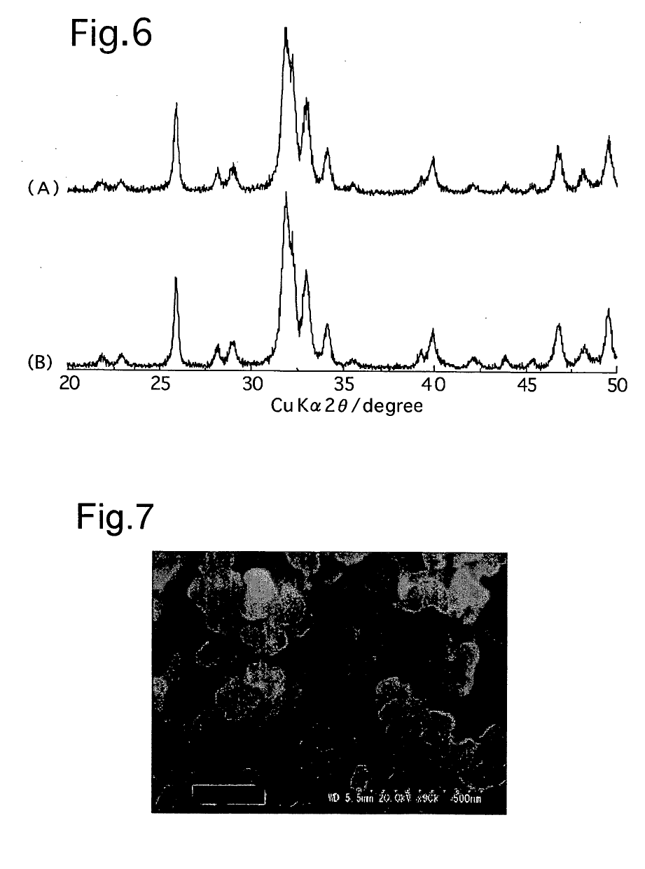

FIG. 6 is X-ray diffraction spectra of the thermally treated HA particles before and after ultrasonication. These X-ray diffraction spectra show the same pattern before and after ultrasonication ((A): before treatment, and (B): after treatment), and hence show that the hydroxyapatite structure is maintained.

The crystallite diameter was about 12 nm upon calculating from the maximum peak of the X-ray diffraction spectrum.

(E) Measurement of Weight Concentration

The weight concentration of the HA nanoparticles of this example is 2.25 mg/ml.

### EXAMPLE 2

HA nanoparticle dispersion liquid of this example was produced in a similar manner to Example 1, except that the thermal treatment temperature in the thermal treatment process was 700° C., and various analysis were performed. In addition, the slurry treated with ultrasonic wave was centrifuged for 10 minutes at 4100×g.

The results of various analysis of the thermally treated HA particles and the HA nanoparticles prepared in this example are shown as follows.

(A) Particle Surface Structure and Average Particle Size

FIG. 7 is a scanning electron microphotograph of the thermally treated HA particles. As observed in FIG. 7, the thermally treated HA particles are not completely sintered even in the thermal treatment process. The thermally treated HA particles are bonded with spherical and oval-spherical primary particles, and the average particle size of the primary particles in the thermally treated HA particles is about 130 nm according to FIG. 7. The microphotograph magnification is 90,000 times.

(B) Particle Size Distribution

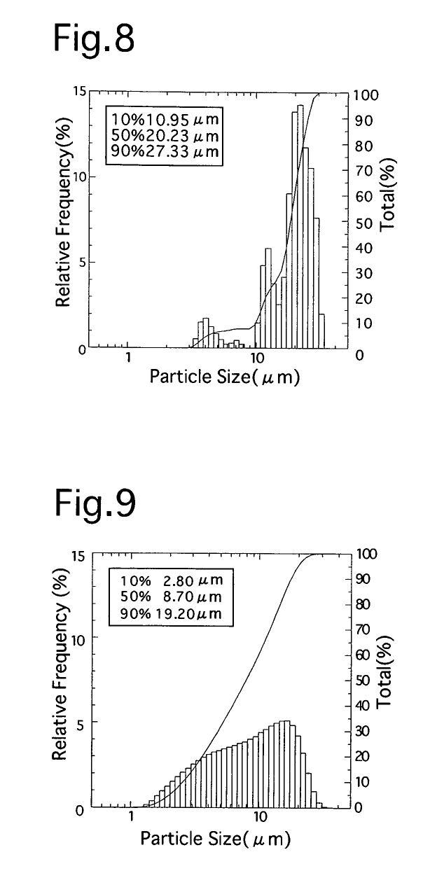

FIG. 8 shows a laser diffraction particle size distribution of the thermally treated HA particles before ultrasonication. Thus, the average particle size of 50% of the thermally treated HA particles before ultrasonication was 20 μm, and the proportion of the particles with a particle size of not more than 10 μm was about 10%, which is very few.

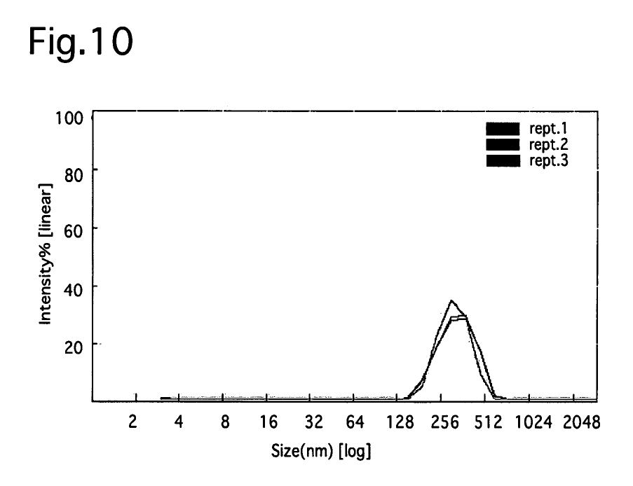

FIG. 9 shows a laser diffraction particle size distribution of the thermally treated HA particles after ultrasonication. The average particle size of 50% of the thermally treated HA particle after ultrasonication was reduced to 8.70 μm, and the proportion of the particles with the particle size of not more than 10 μm increased remarkably. The ultrasonication showed sufficient effect in the crushing procedure. FIG. 10 shows the particle size distribution of the HA nanoparticle dispersion liquid by a dynamic scattering method. The average particle size of the HA nanoparticles in the dispersion liquid is about 330 nm.

(C) Particle Shape and Aspect Ratio

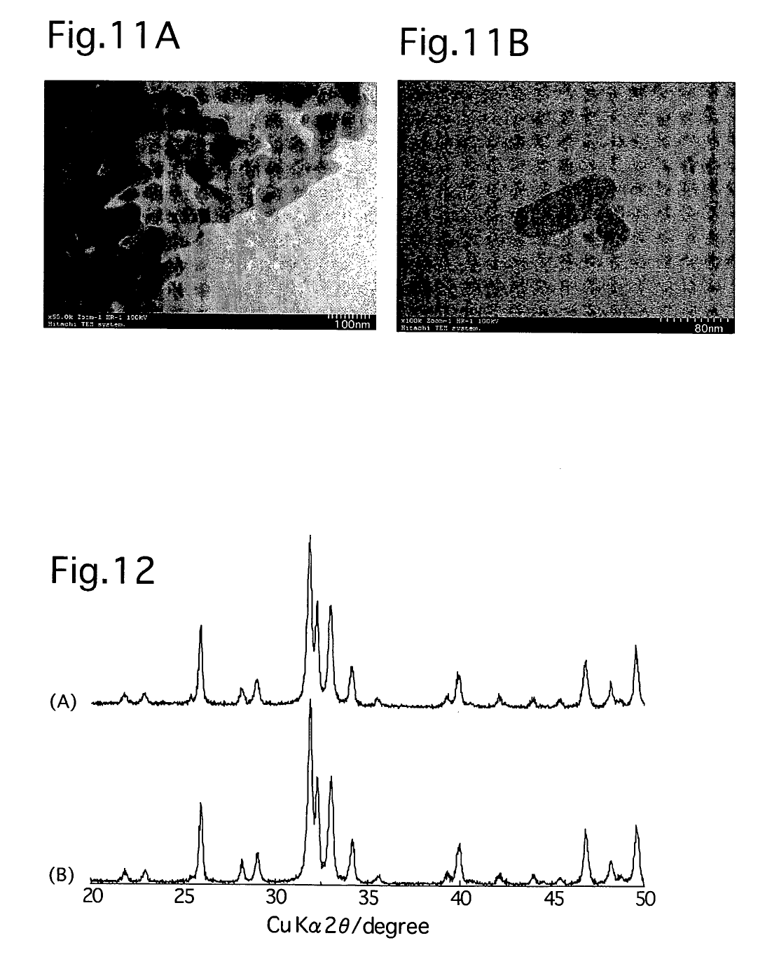

FIG. 11A is a transmission electron microphotograph of HA nanoparticles at a photographic magnification of 50,000 times. FIG. 11B is a transmission electron microphotograph of HA nanoparticles at a photographic magnification of 100,000 times. When calculating the HA nanoparticle dispersion liquid based on FIG. 11, the average particle size of the HA nanoparticles was about 75 nm, the average particle size of the long axis was 75 nm, and the average particle size of the short axis was 35 nm. The HA nanoparticles of this example were spherical or oval spherical.

The aspect ratio was 1.4 to 2.9, and a mean of the aspect ratio was 2.2. An existence ratio of the particles having an aspect ratio less than 2.0 to the particles having an aspect ratio not less than 2.0 is 1:3.

(D) Crystallite Phase

FIG. 12 shows X-ray diffraction spectra of the thermally treated HA particles (A) before and (B) after ultrasonication. These X-ray diffraction spectra show the same spectrum pattern before and after ultrasonication, and the particles maintained a hydroxyapatite structure even after ultrasonication.

The crystallite diameter is about 49 nm upon calculating from the maximum peak of the X-ray diffraction spectrum.

(E) Measurement of Weight Concentration

The weight concentration of the HA nanoparticles of this example was 0.55 mg/ml.

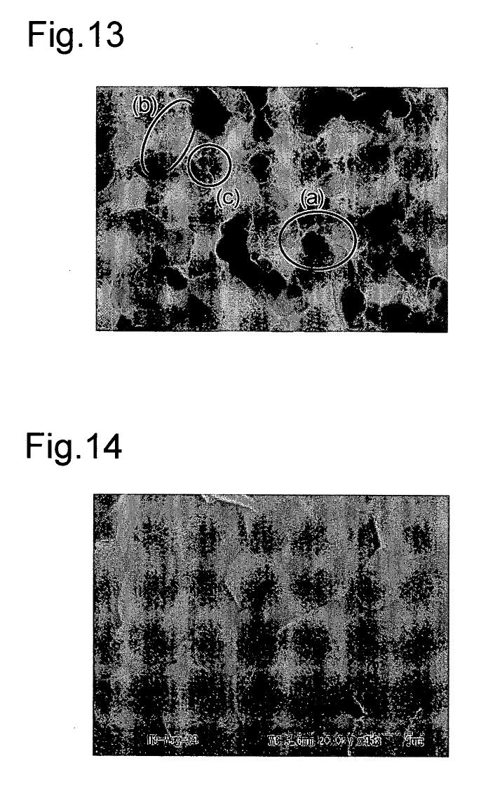

In addition, the shape of the HA nanoparticles prepared in this example was presumed as follows. FIG. 13 is a transmission electron microphotograph (TEM) of the HA nanoparticles of this example. Using this TEM image, the electronic line density was measured and the shape of the HA nanoparticles was presumed. Since FIG. 13 is a transmission image, the contrast of the image of the HA nanoparticles becomes darker (blacker) as the thickness of particles increases under the influence of the thickness of particles.

For example, in (a) of FIG. 13, two HA nanoparticles overlap and therefore the thickness increases as compared with those which do not overlap, and accordingly, the electronic line density becomes weak and consequently the transmission image of the TEM photograph becomes black. Thus, by the contrast of a penetration image of HA nanoparticles, the thickness (height) in a perpendicular direction to the observation side of an electron microscopic sample can be calculated.

As mentioned above, when the shapes of the HA nanoparticles (b) and (c) in FIG. 13 were presumed, the HA nanoparticles (b) and (c) have the same contrast and the electron line densities thereof are similar. In other words, HA nanoparticles (b) and (c) have the same thickness. Consequently, it is recognized that various shapes of particles such as the rice-like granules or spherical particles were mixed in the HA nanoparticle dispersion liquid.

### EXAMPLE 3

The HA nanoparticle dispersion liquid of this example was prepared in a similar manner to example 1 except that the thermal treatment temperature in the thermal treatment process was at 1050° C., and thereafter various analyses were performed.

In addition, the slurry treated with ultrasonic wave was centrifuged for 10 minutes at 4100×g.

The results of various analysis of the thermally treated HA particles and HA nanoparticles prepared in this example are shown as follows.

(A) Particle Surface Structure and Average Particle Size

FIG. 14 is a scanning electron microphotograph of the thermally treated HA particles of this example. As observed in FIG. 14, the thermally treated HA particles are sintered. The primary particles of an infinite form with the average particle size of about 500 nm upon calculating from FIG. 14 are bonded together by the grain boundaries thereof. The photographic magnification is 45,000 times.

(B) Particle Size Distribution

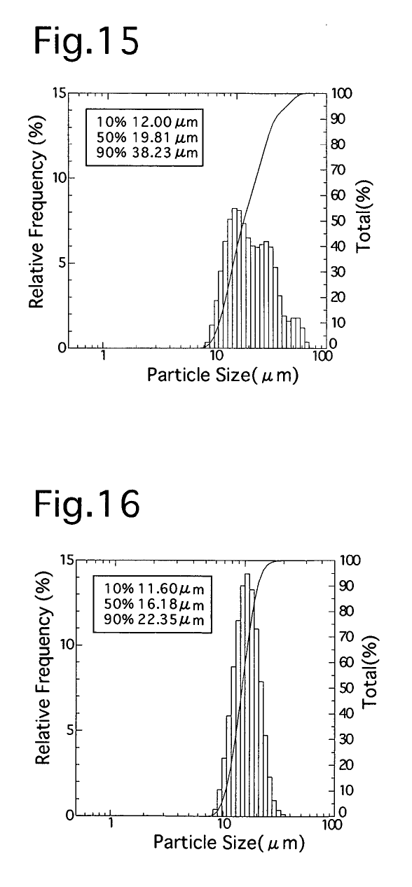

FIG. 15 is a graph of a laser diffraction particle size distribution of the thermally treated HA particles before ultrasonication. Thus, the average particle size of 50% of thermally treated HA particles before ultrasonication was 19.81 μm, and many particles with a diameter of 30 to 40 nm also existed which are aggregates in which many particles granulated having a diameter of about 20 μm.

FIG. 16 is a graph of a laser diffraction particle size distribution of the thermally treated HA particles after ultrasonication. Most particles with a diameter of 30 to 40 nm had disappeared because the aggregates had been crushed by ultrasonication.

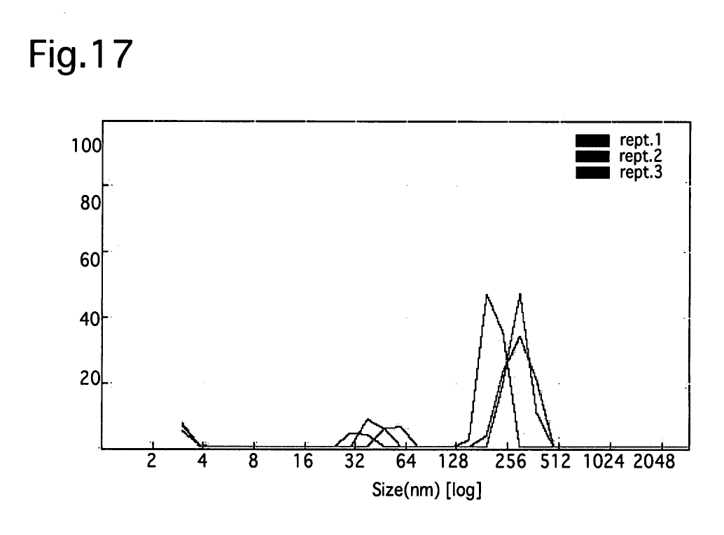

FIG. 17 is a graph of a particle size distribution of HA nanoparticle dispersion liquid by a dynamic scattering method. The average particle size of the HA nanoparticles in the dispersion liquid is about 260 nm.

(C) Particle Shape and Aspect Ratio

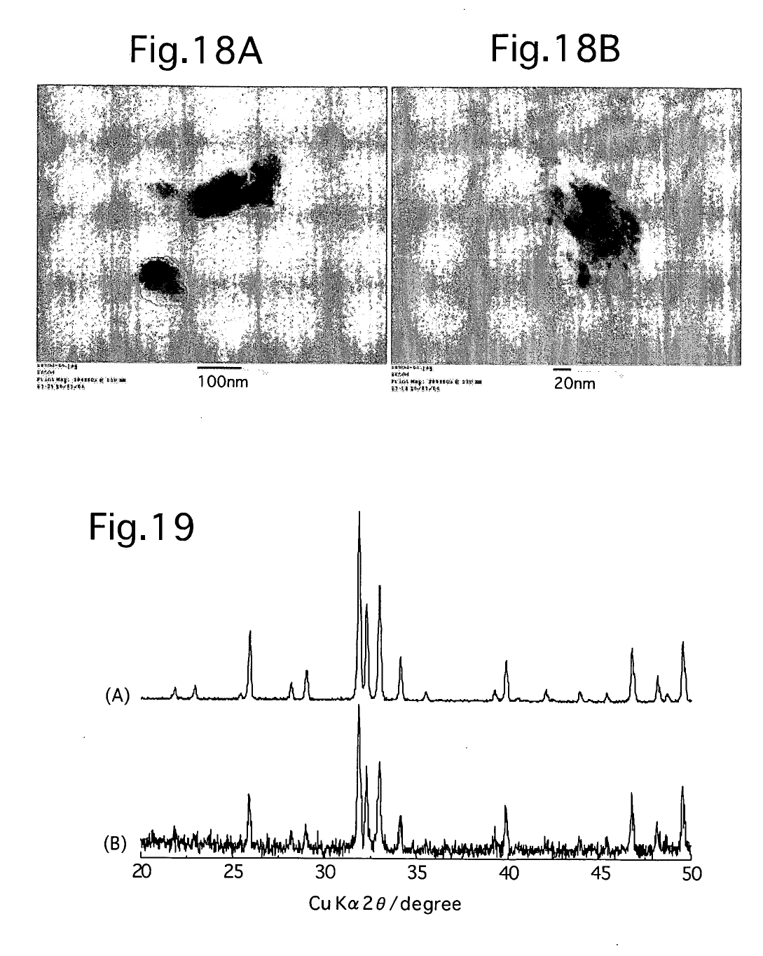

FIG. 18A and FIG. 18B show scanning electron microphotographs of each HA nanoparticles, respectively. According to FIG. 18, the average particle size of the HA nanoparticles was about 85 nm, and the average particle size of the long axis was 85 nm and the average particle size of short axis was 45 nm. HA nanoparticles of this example were spherical or oval-spherical.

The aspect ratio was 1.0 to 2.7, and the mean of the aspect ratio was 1.8. The existence ratio of the particles having an aspect ratio less than 2.0 and the particles having an aspect ratio not less than 2.0 is 4:1. The photography magnification is 30,000 times in FIG. 18A and 60,000 times in FIG. 18B.

(D) Crystalline Phase

FIG. 19 shows X-ray diffraction spectra of the thermally treated HA particles (A) before and (B) after ultrasonication. These X-ray diffraction spectra showed the same spectrum pattern before and after ultrasonication, i.e., showed a sharp peak even after ultrasonication and it maintained a hydroxyapatite structure that has good crystallinity.

The crystallite diameter was about 73 nm upon calculating from the maximum peak of the X-ray diffraction spectrum.

(E) Weight Concentration Measurement

Weight concentration of the HA nanoparticles of this example was 0.07 mg/ml.

### EXAMPLE 4

HA nanoparticle dispersion liquid of this example was prepared as follows.

The thermally treated HA nanoparticles were prepared in a similar manner to example 1 except that they were classified to provide the particles with the average particle size of 4 μm and the thermal treatment temperature of the thermal treatment was changed to 950° C. This thermally treated HA particles were dense and in a dry condition.

0.2 g of the thermally treated HA particles were placed in a pot (made from zirconia) with a content of 45 ml and they were dry mill treated (hereinafter, called dry milling) with Planetary ball mill (made by Fritsch, Ltd.: P-7) at a milling rotation of 800 rpm for 15, 48, and 72 hours (milling process). Furthermore, the ball milling was conducted without using balls (made from zirconia), for a Planetary ball mill, in the pot in a Planetary ball mill apparatus.

After dry milling, the thermally treated HA particles were dispersed in 10 ml of isopropanol, and thereafter ultrasonication was carried out (at output 60 W for 15 min) using an ultrasonic generator (made in TAITEC Ltd.: VP-30S) (a crushing process). Subsequently, the dispersion liquid was centrifuged at 4100×g for 10 minutes to obtain a supernatant (HA nanoparticle dispersion liquid) (separation process).

The results of various analyses of the thermally treated HA particles and the HA nanoparticles prepared in this example are shown as follows. In addition, to observe (A) a surface structure and an average particle size of the particles, a scanning electron microscope (S-4300 made by HITACHI, Ltd., JAPAN) was used. The analysis of (B) particle size distribution and (C) crystalline phase was performed for the thermally treated HA particles before and after dry milling (before dry milling, and after ultrasonication after dry milling). Various analyses were carried out with the same procedures and analytical devices as those of example 1.

(A) Particle Surface Structure and Average Particle Size

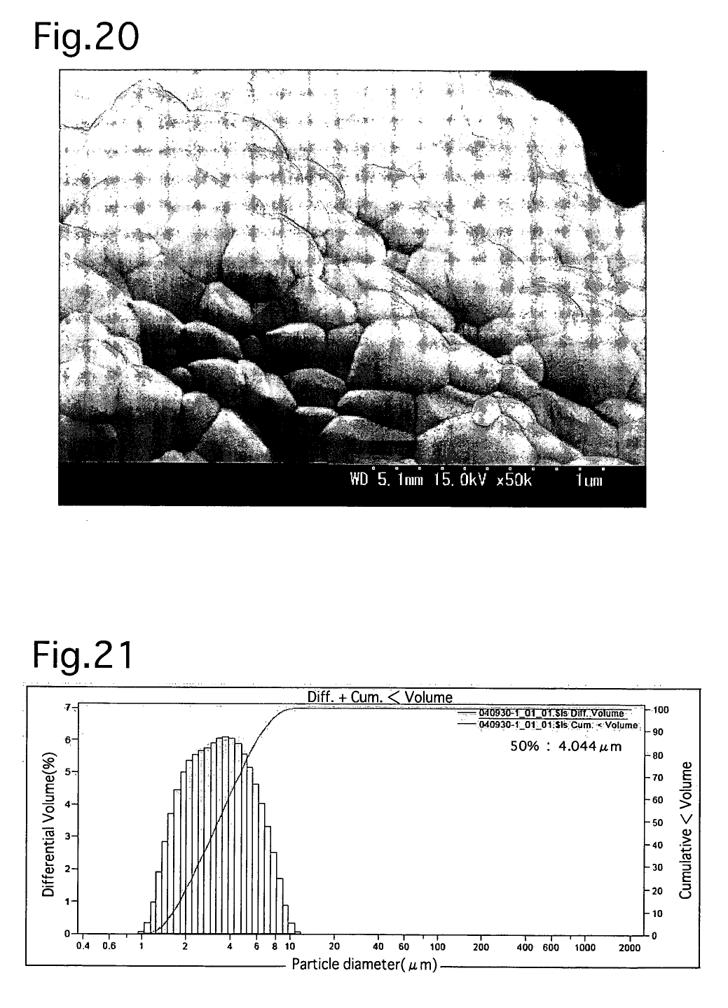

FIG. 20 is a scanning electron microphotograph of the thermally treated HA particles in this example. As observed in FIG. 20, the thermally treated HA particles, in which the primary particles subjected to grain growth by heat treatment are bonded each other, are lowered in porosity, i.e., are dense. According to FIG. 20, the average particle size of the primary particles in the thermally treated HA particles is about 250 nm. The photographic magnification is 50,000 times.

(B) Particle Size Distribution

FIG. 21 is a graph of the laser diffraction particle size distribution of the thermally treated HA particles before dry milling. The average particle size of 50% of all HA particles is about 4 μm.

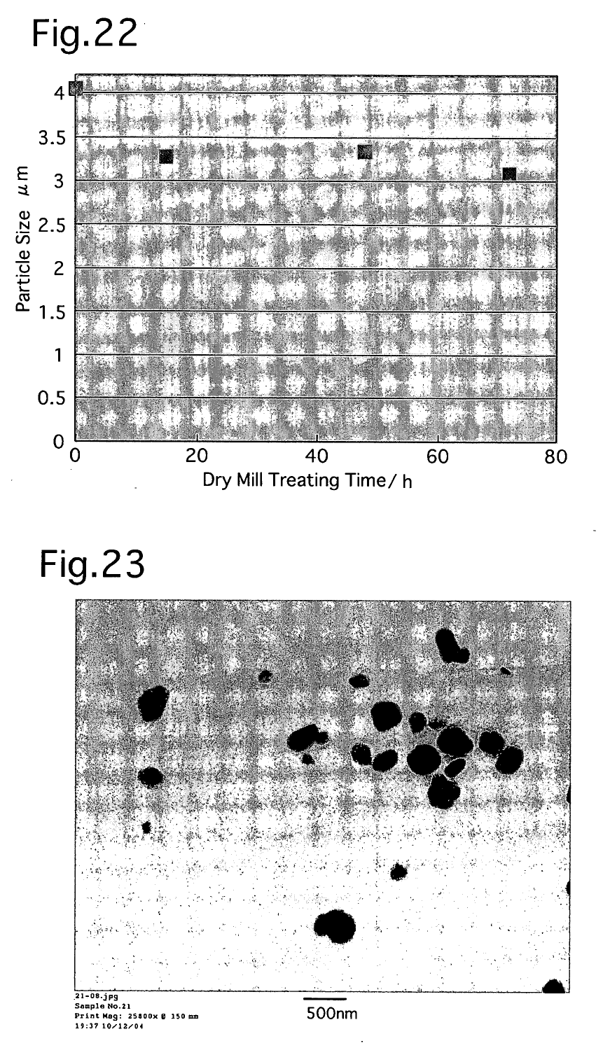

FIG. 22 shows a relationship between dry milling time (15, 48, and 72 hours) and the 50% average particle size. The 50% average particle size was calculated from the result of determining a particle size distribution of the thermally treated HA particles after dry milling. The 50% average particle size were reduced in comparison with those before treating (0 hours; 4 μm), however, the values were almost fixed regardless of time (15 hours; 3.26 μm, 48 hours; 3.33 μm, 72 hours; 3.09 μm). The dry milling showed a sufficient crushing effect.

The average particle size of the HA nanoparticles in the dispersion liquid was about 240 nm regardless of time, which was measured by a dynamic scattering method.

(C) Particle Shape and Aspect Ratio

FIG. 23 is a transmission electron microphotograph of HA nanoparticles (dry mill treatment time, 15 hours) of this example. Calculating from this TEM photograph, the average particle size of HA nanoparticles was about 157 nm, the average particle size of long axis was 182 nm, and the average particle size of short axis was 141 nm. The HA nanoparticles in this example were spherical or rounded polygonal. The shape and the average particle size were independent of treating time. Aspect ratio was 1.0 to 2.9 and the average of the aspect ratio was 1.37.

(D) Crystallite Phase

According to X-ray diffraction spectra (not shown) of the thermally treated HA particles before and after dry mill treatment, they showed the same spectrum patterns, and the thermally treated HA particles kept a hydroxyapatite structure even after dry mill treatment.

Crystal diameter was about 75 nm when calculated from the maximum peak of each X-ray diffraction spectrum regardless of the dry mill treatment time.

(E) Measurement of Weight Concentration

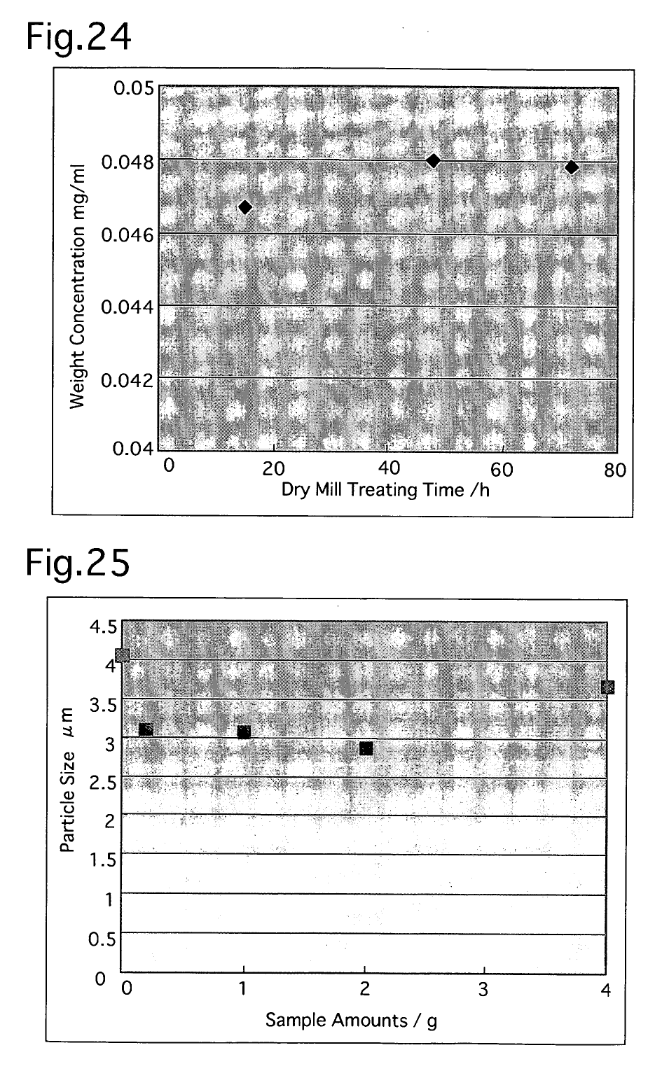

FIG. 24 shows the relationship between the dry mill treatment time and the weight concentrations of each HA nanoparticle of this example. The weight concentration of the HA nanoparticles was almost fixed at about 0.05 mg/ml regardless of the dry mill treatment time (15 hours: 0.047 mg/ml; 48 hours: 0.048 mg/ml; 72 hours: 0.048 mg/ml).

In addition, to examine the relationship between the amount of sample and the particle distribution, and the relationship between the amount of sample and the weight concentration of HA nanoparticles, the examination was conducted as follows.

0.2 g, 1.0 g, 2.0 g and 4.0 g samples of the thermally treated HA nanoparticles were treated by dry milling (72 hours), and the obtained thermally treated HA particles are analyzed for (B) particle size distribution and (E) weight concentration. The obtained results are shown as follows.

(B) Particle Size Distribution

FIG. 25 shows the relationship between the 50% average particle size of the sample amounts by dry mill treatment (containing non-treating) and the thermally treated HA particles after dry mill treatment. The 50% average particle size was calculated from the result of the measurement of the particle size distribution of the thermally treated HA particles after dry mill treatment. The 50% average particle size was reduced (0.2 g: 3.09 μm; 1.0 g: 3.08 μm; 2.0 g: 2.86 μm; 4.0 g: 3.68 μm) as compared with that before dry mill treatment (0 hours: 4 μm) regardless of the amount of the sample (0.2 g through 4.0 g).

(E) Weight Concentration Measurement

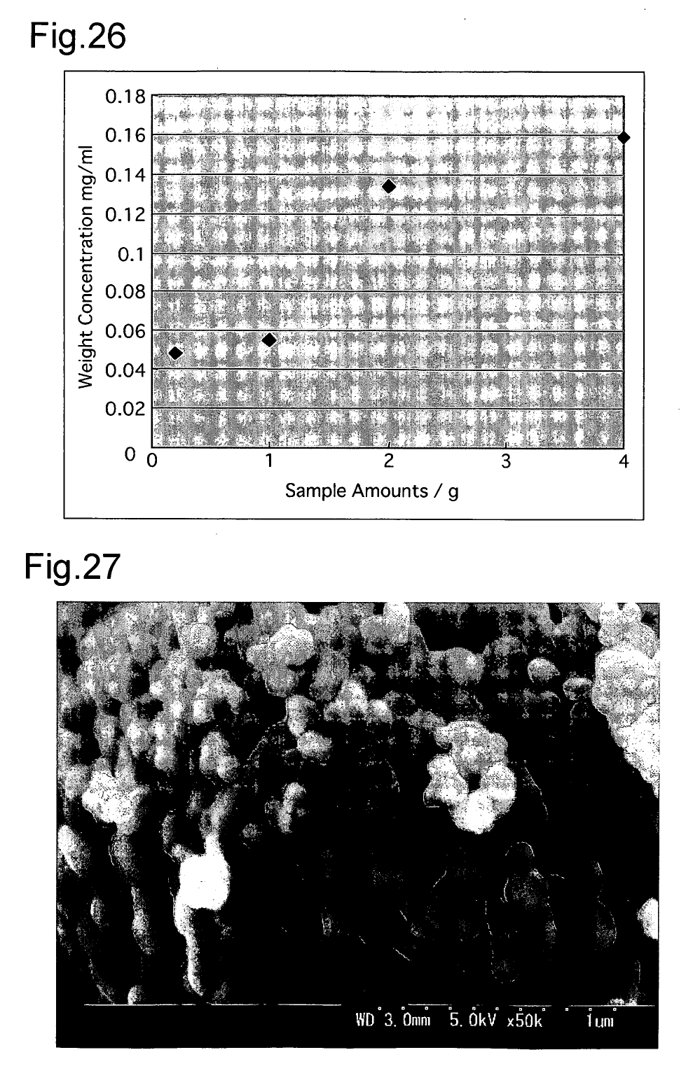

FIG. 26 shows the relationship between the amount of sample of the thermally treated HA particles provided with dry mill treatment (containing untreated) and the weight concentrations of HA nanoparticles. The weight concentration of each of the HA nanoparticles was about 0.05 through 0.16 mg/ml, and increased following the increase of the quantity of the sample (0.2 g: 0.048 mg/ml; 1.0 g: 0.055 mg/ml; 2.0 g: 0.134 mg/ml; 4.0 g: 0.159 mg/ml).

### EXAMPLE 5

The dispersion liquid of HA nanoparticles of this example was prepared by the same process as Example 4, except that thermal treatment of the thermal treatment process was performed at 900° C., for 4 hours to produce the thermally treated HA particles that are porous with a mean particle size of 4 μm, and amount of sample was changed to 2.0 g and dry mill treatment time was changed to 1, 5, 15, 48 hours, respectively, and various analyses were conducted.

The results of various analyses results of thermally treated HA particles and HA nanoparticles prepared in this example were shown as follows. In addition, centrifuge process (4100×g, 10 min) was performed.

(A) Particle Surface Structure and Mean Particle Size

FIG. 27 is a scanning electron microphotograph of the thermally treated HA particles of this example. As observed in FIG. 27, the thermally treated HA particles were porous and primary particles were bonded by granular border. According to FIG. 27, the average particle size of the primary particles is about 165 nm. The magnification is 50,000 times.

(B) Particle Size Distribution

According to the result of measuring the thermally treated HA particles in this example by laser diffraction particle size distribution (not shown) before dry mill treatment, the 50% average particle size was about 4.07 μm.

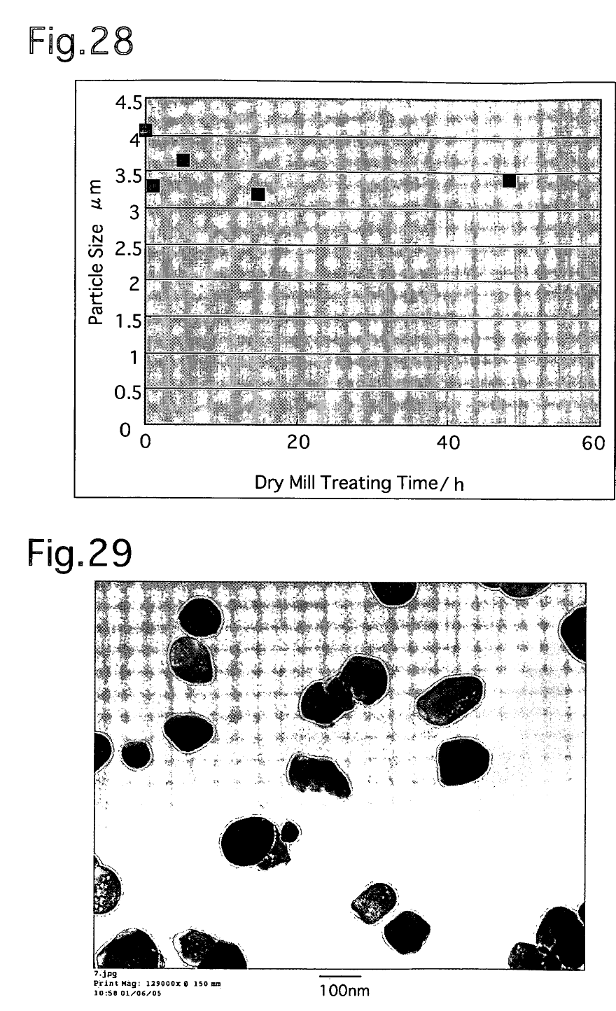

FIG. 28 shows a relationship between dry mill treatment time (1, 5, 15, 48 hours) and the 50% average particle size of thermally treated HA particles. The 50% average particle size was calculated from the measurement result of particle size distribution of the thermally treated HA particles after dry mill treatment. The 50% average particle size was reduced as compared with one before dry mill treatment (0 hours: 4.07 μm), but showed an almost constant value with independent of the treating time (1 hour; 3.31 μm; 5 hours: 3.67 μm; 15 hours: 3.20 μm; 48 hours: 3.42 μm). The dry mill treatment showed a sufficient crushing effect.

When the average particle size of HA nanoparticles in the dispersion liquid of HA nanoparticles was measured by a dynamic scattering method, it was about 223 nm which was not related to the dry mill treatment time.

(C) Particle Shape and Aspect Ratio

FIG. 29 is a transmission electron microphotograph of HA nanoparticles of this example. Calculating based on this TEM photograph, the average particle size was about 111 nm which was not related to the dry mill treatment time (1 hour: 108 nm; 5 hours: 120 nm; 15 hours: 105 nm; 48 hours: 121 nm), the average particle size of long axis was 130 nm, the average particle size of short axis was 97.6 nm. HA nanoparticles in this example were spherical or in a shape of a rounded polygon. The aspect ratio was 1.0 to 2.8, the mean value of aspect ratio was 1.35.

(D) Crystalline Phase

According to the X-ray diffraction spectrum (not shown) of the thermally treated HA particles before and after dry mill treatment, they showed the same spectrum patterns and the thermally treated HA particles maintained a hydroxyapatite structure even after dry mill treatment.

The crystallite diameter was about 64 nm which was not related to the dry mill treatment time on calculating from the maximum peak of each X-ray diffraction spectrum.

(E) Measurement of Weight Concentration

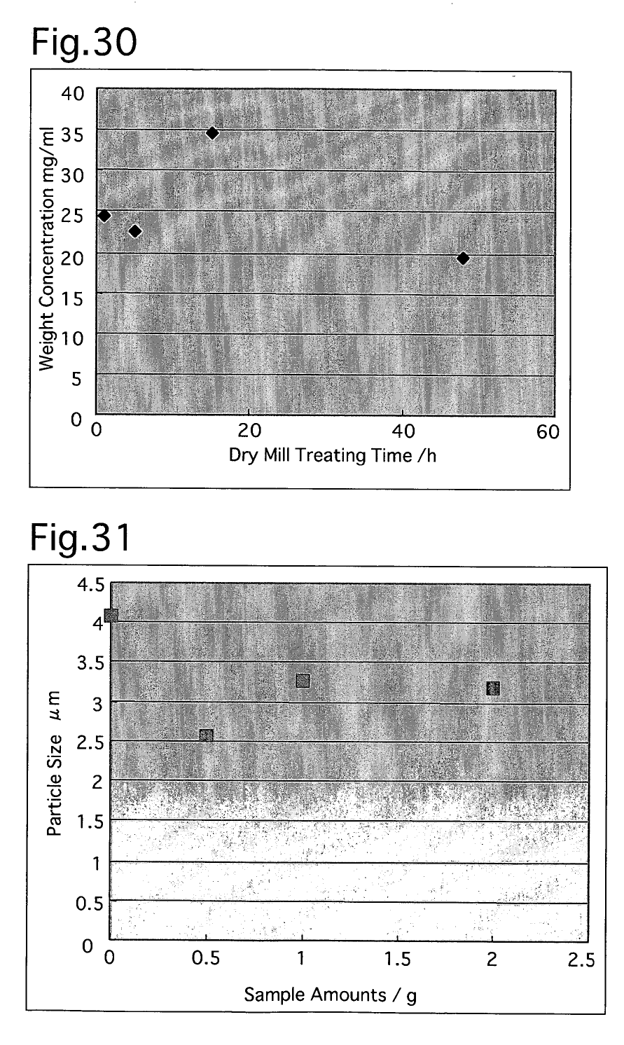

FIG. 30 shows the relationship between the amounts of the sample with dry mill treatment and the weight concentrations of HA nanoparticles. The weight concentration of HA nanoparticles were about 20 to 35 mg/ml regardless of the treating time (1 hour: 24.4 mg/ml; 5 hours: 22.7 mg/ml; 15 hours: 34.6 mg/ml; 48 hours: 19.4 mg/ml). The concentration of HA nanoparticles had almost no dependency on the dry mill treatment time.

Since ultrasonication is performed by putting a vibrator into liquid to carry out the crushing of particles in the convection of the liquid, the condition of the convection may change and influence the concentration of HA nanoparticles.

In the thermally treated HA particles of this example, the dry mill treatment (treatment time, 15 hours) was carried out by changing the sample amounts to 0.5 g, 1.0 g and 2.0 g, respectively, and the particle size distribution (B) and the weight concentration (E) of the obtained thermal HA particles were analyzed. These results are shown as follows.

(B) Particle Size Distribution

FIG. 31 shows a relationship between the amounts of sample which is dry mill treated (include non-treated) and the 50% average particle size of the thermally treated HA particles after dry mill treatment. The 50% average particle size was calculated from the result of the measurement of the particle size distribution of the thermally treated HA particles after dry mill treatment. The 50% average particle size was reduced (0.5 g: 2.58 μm; 1.0 g: 3.27 μm; 2.0 g: 3.20 μm) as compared with one before dry mill treatment (0 hours: 4.07 μm). However, when the amount of the sample was 1.0 g and 2.0 g, the particle size of the samples was larger compared with the sample of 0.5 g, and there were some thermally treated HA particles which were not contributed to dry mill treatment. In this example, there were some particles which did not contribute to treating depending on the bulk density, even if the amount of sample was smaller than that of Example 4.

(E) Measurement of Weight Concentration

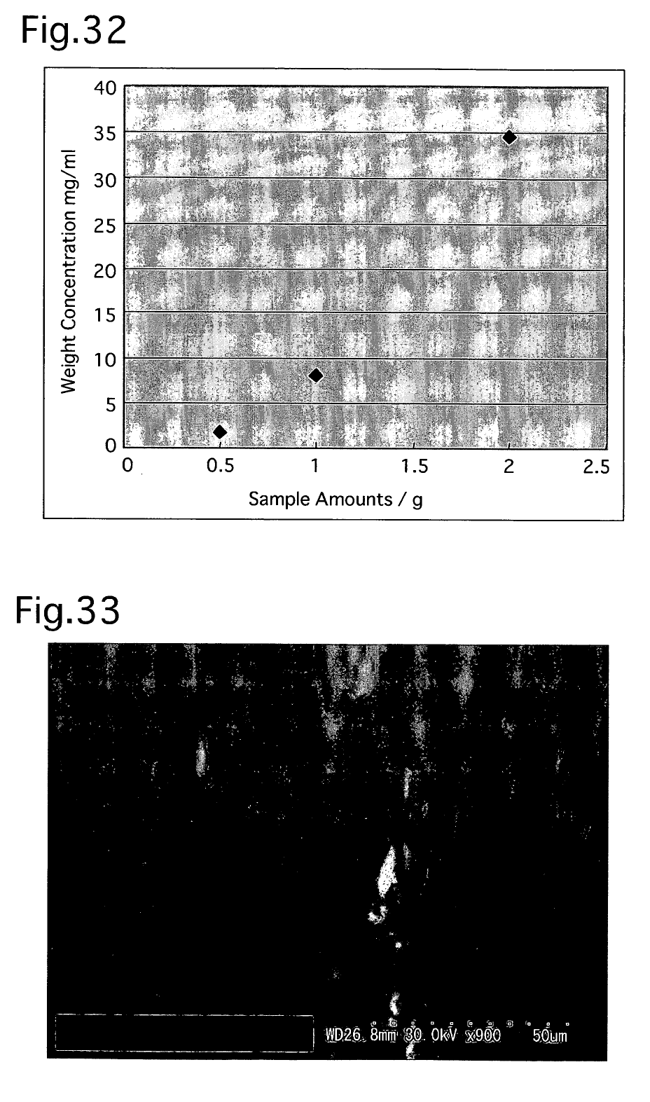

FIG. 32 shows a relationship between the amounts of dry mill treated sample and the weight concentrations of HA nanoparticles. Weight concentration of HA nanoparticles were about 1.5 to 35 mg/ml and increased with increase in the sample amounts (0.5 g: 1.67 mg/ml; 1.0 g: 8.06 mg/ml; 2.0 g: 34.6 mg/ml).

The shape and the particle size of HA nanoparticles in this example were not related to the sample amounts.

### EXAMPLE 6

The dispersion liquid of HA nanoparticles in this example was prepared in the similar manner to Example 4, except that dense thermally treated HA particles having an average particle size of 10 μm were prepared, time for dry mill treatment was changed to 15 hours, and various analyses were conducted.

Various analysis results of the thermally treated HA particles and HA nanoparticles prepared in this example are shown as follows. In addition, the slurry which was treated by ultrasonic wave was centrifuged at 4100×g for 10 min.

(A) Particle Structure and Average Particle Size

According to a scanning electron microphotograph (not shown) of thermally treated HA particles, the primary particles were bonded each other by particle border and the thermally treated HA particles were dense, having less porosity. The average particle size of the primary particle was about 170 nm.

(B) Particle Size Distribution

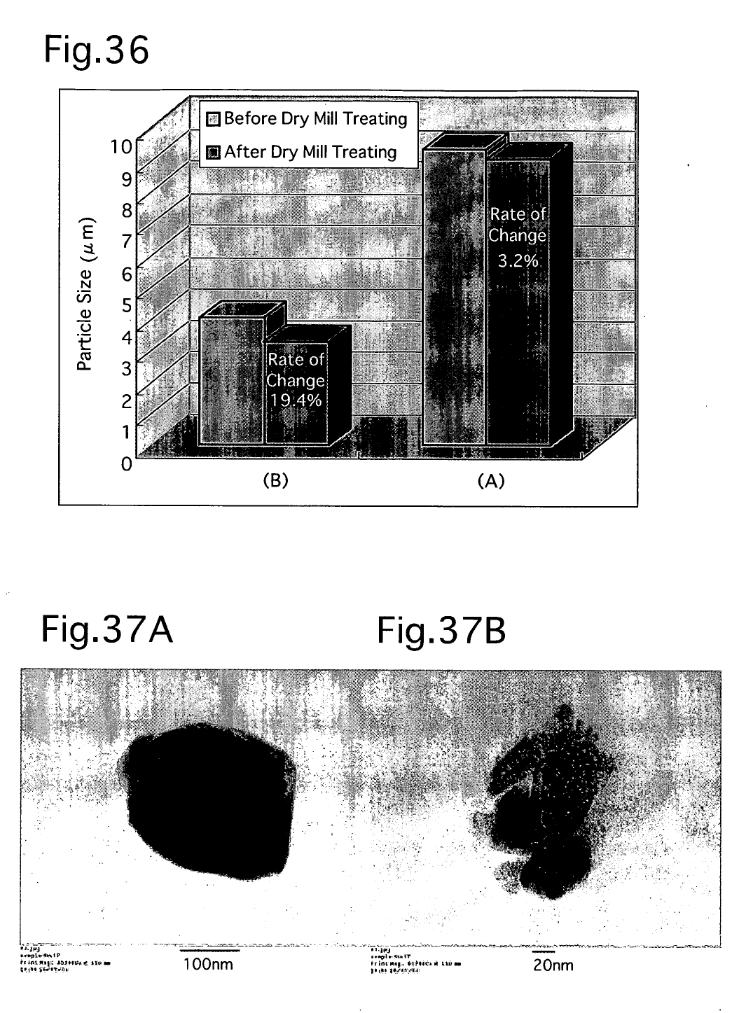

According to the result of measuring the thermally treated HA particles before the dry mill treatment using a laser diffraction particle size distribution (not shown), the 50% average particle size was about 9.33 g m. FIG. 36 shows the 50% average particle size of thermally treated HA particles in this example before and after dry mill treatment (A), and shows the 50% average particle size of the thermally treated HA particles with an average particle size of 4 μm in Example 4 (B), before and after dry mill treatment for 15 hours. The 50% average particle size was calculated from the result of determining particle size distribution (not shown) of the thermally treated HA particles after dry mill treatment. The 50% average particle size of the thermally treated HA particles in this example were reduced compared to that before treating (0 hours: 9.33 μm), however, the rate of change (reducing rate) was 3.2% (15 hours: 9.03 μm), which is very few. In the sample of Example 4, the changing rate was 19.4% (15 hours: 3.26 μm)

(C) Particle Shape and Aspect Ratio

FIG. 37A and FIG. 37B are transmission electron microphotographs of HA nanoparticles of this example. Based on this TEM photograph, the HA nanoparticles of this example consisted of part of particles of about 100 nm and major parts of particles not more than 100 nm. The particles that had a particle size of about 100 nm were spherical or a rounded polygon, the particles that had a particle size of not more than 100 nm had the average particle size of 28 nm, and the aspect ratio was 1.0 to 4.7. The average of aspect ratio was 1.87. The existence ratio of the particles with particle size of about 100 nm and the particles with not more than 100 nm was 1:130, and the shape of finely divided particles (HA nanoparticles) obtained differed depending on the average particle size (4 μm or 10 μm) of the thermally treated HA particles.

(D) Crystallite Phase

According to the X-ray diffraction spectra (not shown) of the thermally treated HA particles of this example before and after dry mill treatment, these showed the same spectrum pattern, and thermally treated HA particles maintained the hydroxyapatite structure even after dry mill treatment.

The crystallite diameter of the particle that is about 100 nm was about 74 nm upon calculating from the maximum peak of each X-ray diffraction spectrum.

(E) Measurement of Weight Concentration

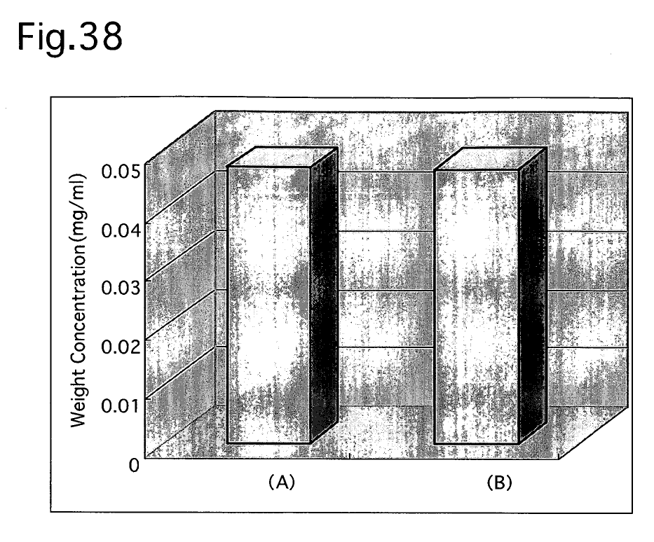

In FIG. 38, (A) shows the result of weight concentration measurement of HA nanoparticles of this example. The weight concentration of HA nanoparticles is about 0.05 mg/ml, and (B) shows the result of weight concentration measurement of HA nanoparticles of Example 4. The weight concentration of HA nanoparticles was almost constant value regardless of the average particle size of thermally treated HA particles.

### EXAMPLE 7

The dispersion liquids of HA nanoparticles of this example were prepared in a similar manner to Example 4, except that the temperature of the thermal treatment was changed to 400, 700, 900 and 950° C. to make thermally treated HA particles, and the dry mill treatment time was set to 15 hours.

Various analysis results of the thermally treated HA particles and HA nanoparticles prepared according to this example are shown as follows.

(A) Particle Surface Structure and Average Particle Size

According to a scanning electron microphotograph (not shown) of the thermally treated HA particles of this example, the thermally treated HA particles which were prepared at the temperature of thermal treating of 400° C. and 700° C. were porous, and the primary particles were bonded by a grain boundary. The thermally treated HA particles prepared at the thermal treatment temperature of 950° C., in which the primary particles were bonded each other by a grain boundary, had lowered porosity, i.e., are dense. The thermally treated HA particles at the thermal temperature of 900° C. were neither porous nor dense.

(B) Particle Shape and Aspect Ratio

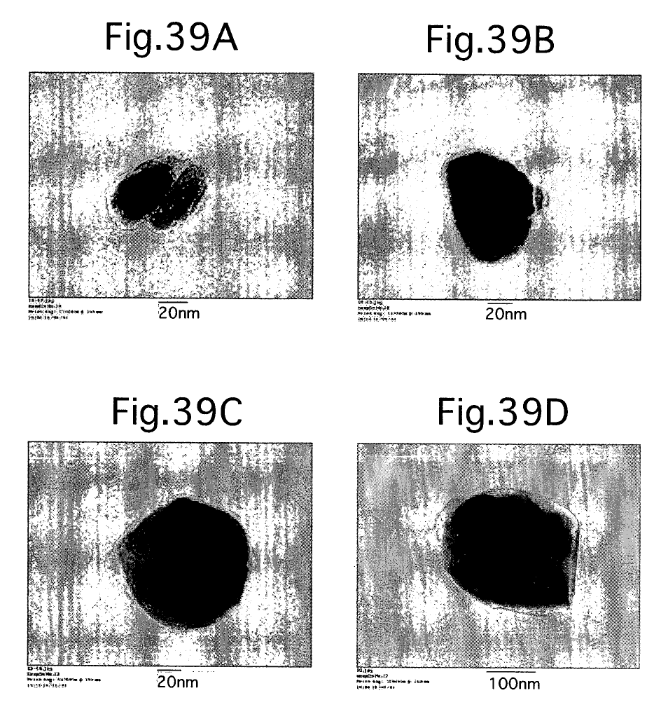

FIGS. 39A, 39B, 39C and 39D show scanning electron microphotographs of the thermally treated HA nanoparticles in this example when the thermal treatment temperature was set to 400° C., 700° C., 900° C. and 950° C., respectively. The HA nanoparticles obtained at the temperature of 400° C. or 700° C. were spherical or oval-spherical, whereas the HA nanoparticles obtained at the treatment temperature of 900° C. or 950° C. were spherical or in a shape of rounded polygon.

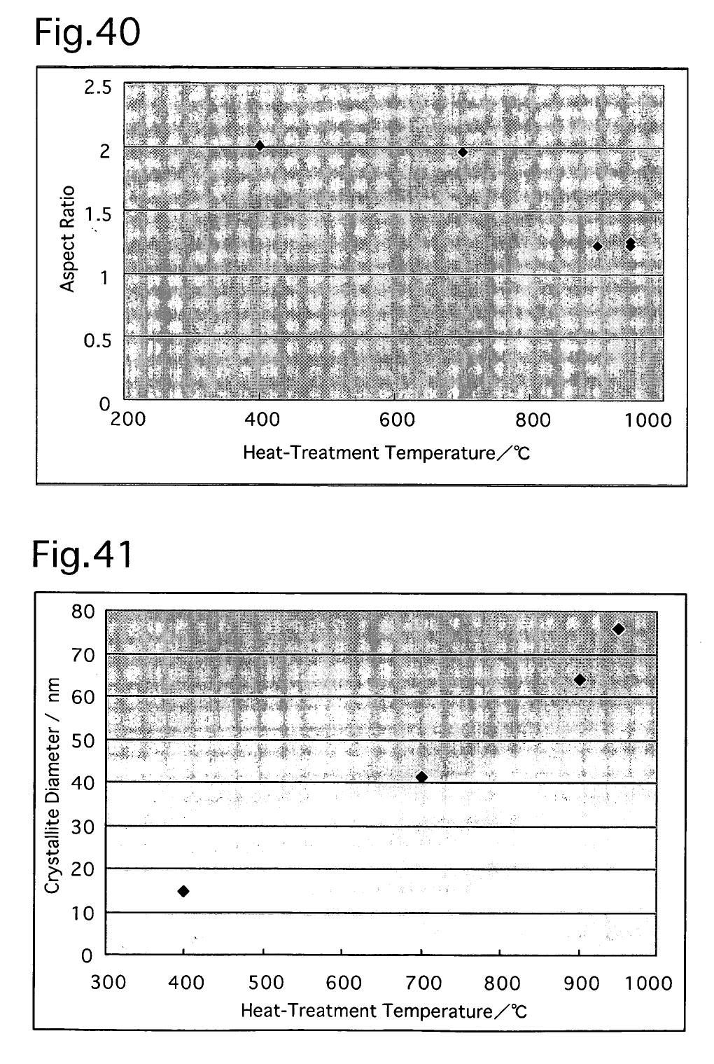

FIG. 40 shows a relationship between the each thermal treating temperature and the aspect ratio (mean value) of HA nanoparticles obtained at the corresponding temperature (400° C.: 2.01; 700° C.: 1.96; 900° C.: 1.22; 950° C.: 1.22). The HA nanoparticles obtained at the temperatures 400° C. and 700° C. which showed low cyrstallinity, had aspect ratios of about 2, and HA nanoparticles at the temperatures 900° C. and 950° C. were reduced to 1.22 and were close to being spherical.

(C) Crystalline Phase

According to the X-ray diffraction spectra (not shown), these showed the same spectrum pattern, and the thermally treated HA particles maintained the hydroxyapatite structure even after dry mill treatment.

FIG. 41 shows the relationship between the each temperature of thermal treatment and the crystalline diameter of corresponding HA nanoparticles. The crystalline diameter increases proportionally to the increase of the thermal treating temperature to improve the crystallinity. The crystallite diameters were calculated from the maximum peak of each X-ray diffraction spectrum (400° C.: 14.78 nm; 700° C.: 41.38 nm; 900° C.: 63.90 nm; 950° C.: 76.03 nm).

(D) Measurement of Weight Concentration

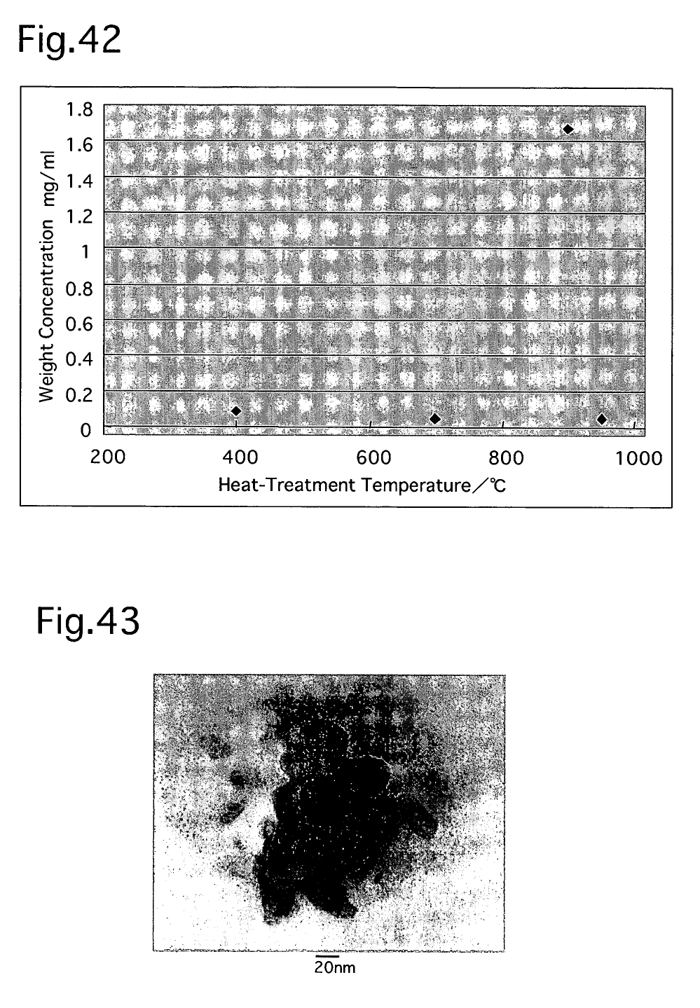

FIG. 42 shows the relationship between the thermal treating temperature and the weight concentration of each HA nanoparticles in this example. The weight concentration of HA nanoparticles increased remarkably at a thermal treating temperature close to 900° C., and decreased again at higher temperature (close to 950° C.) (400° C.: 0.094 mg/ml; 700° C.: 0.050 mg/ml; 900° C.: 1.67 mg/ml; 950° C., 0.047 mg/ml). In order to obtain such nanoparticles with a low aspect ratio and having a near spherical shape, it is desirable for control the temperature of thermal treating so that the temperature is close to sintering temperature and so that the particles do not sinter completely so as to be left with pores.

### EXAMPLE 8

The dispersion liquid of HA nanoparticles in this example was prepared in a similar manner to Example 5 except that the ultrasonication (60 W, 1 hour) was carried out in the presence of 3 ml of isopropanol instead of the dry mill treatment, and following ultrasonic treating and various analyses were conducted.

Various analysis results of the thermally treated HA particles and HA nanoparticles prepared in this example were shown as follows.

(A) Particle Surface Structure and Average Particle Size

The thermally treated HA particle obtained in this example was the same as Example 5.

(B) Particle Size Distribution

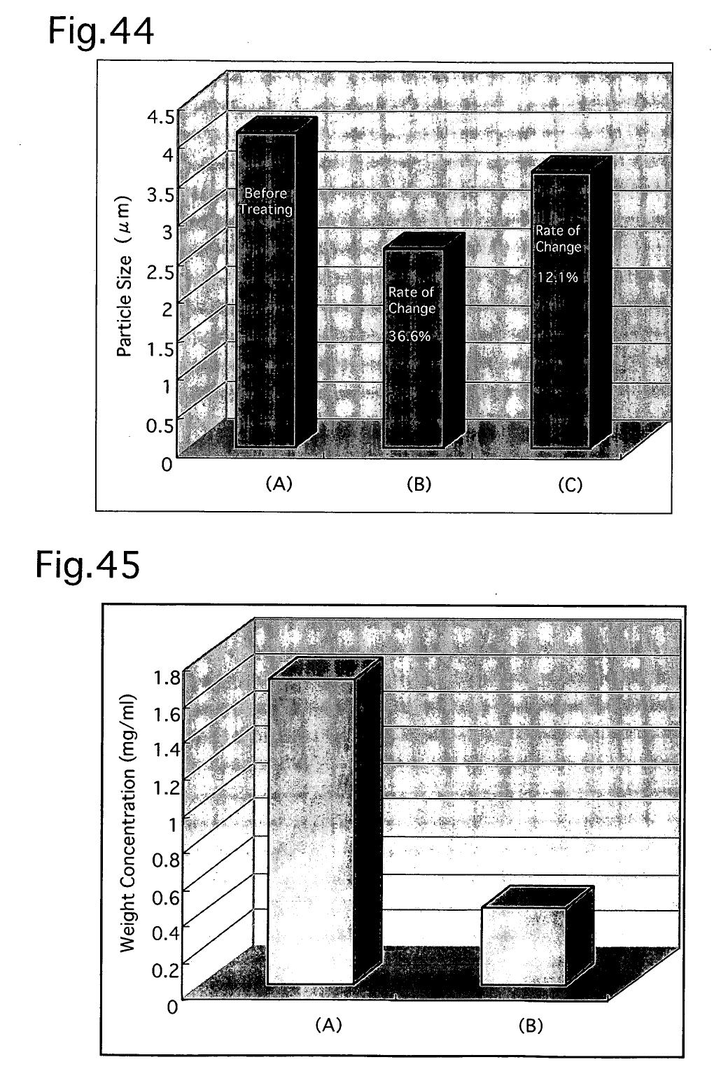

FIG. 44 (A) shows the 50% average particle size (4.07 μm) of the thermally treated HA particle before ultrasonication. FIG. 44(B) shows the 50% average particle size of the thermally treated particles in the case of a 1 hour dry mill treatment in Example 5 (2.58 μm, changing rate (reducing rate) 36.6%). FIG. 44 (C) shows the 50% average particle size (3.58 μm, changing rate 12.1%) of the thermally treated particles after ultrasonication of this example. The 50% average particle size was calculated from the result of the size distribution measurement. The 50% average particle size was reduced compared with that before ultrasonication (0 hour; 4.07 μm), and reduced additionally in the case of dry mill treatment.

(C) Particle Shape and Aspect Ratio

According to a transmission electron microphotograph of HA nanoparticles in this example, the average particle size of the HA nanoparticles was about 127 nm, the average particle size of long axis was 154 nm, and the average particle size of short axis was 113 nm. The HA nanoparticles of this example were spherical or in a shape of a rounded polygon.

The aspect ratio was 1.0 to 2.7, and the mean of aspect ratio was 1.39.

(D) Crystallite Phase

According to the X-ray diffraction spectra (not shown) of the thermally treated HA particles before and after ultrasonication, they showed the same spectrum pattern, and the thermally treated HA particles maintained the hydroxyapatite structure even after dry mill treatment.

The crystallite diameter was about 62 nm on calculating from the maximum peak of each X-ray diffraction spectrum.

(E) Measurement of Weight Concentration

FIG. 45 (A) shows the measurement result of the weight concentration of HA nanoparticles of Example 5 (with dry mill treatment). The weight concentration of HA nanoparticles was 1.6 mg/ml. FIG. 45 (B) shows the measurement result of the weight concentration of HA nanoparticles of this example. The weight concentration of the HA nanoparticles was 0.37 mg/ml. Dry milling achieved a higher concentration of HA nanoparticles compared to ultrasonication.

As mentioned above, it is possible to obtain HA nanoparticles having the same shape and the same particle size regardless of whether they have undergone dry milling or ultrasonication. The weight concentration is higher and the yield is higher when the dry mill treatment was carried out. Accordingly, it is desirable for the dry milling treatment be conducted in industrial applications (in case of a large amount required).

### EXAMPLE 9

Evaluation of the Dispersibility by Dispersion Medium

0.1 g of the thermally treated HA particles prepared in Example 1 was dispersed in 1 ml of each dispersion medium (mentioned below), and thereafter ultrasonication was performed in a similar manner to Example 1. Thereafter, centrifuging at 8160×g for 10 minutes was conducted, the resulting supernatants were collected to provide the HA nanoparticle dispersion liquids. The dispersion mediums used in this example were three kinds of organic solvents that are isopropanol (hereinafter called IPA), dimetylsulphoxide (hereinafter called DMSO), dimetylformamide (hereinafter called DMF).

Each HA nanoparticle dispersion liquid in this example was subjected to their particle size distributions investigation and the scanning electron microscopic observation. The results are shown as follows.

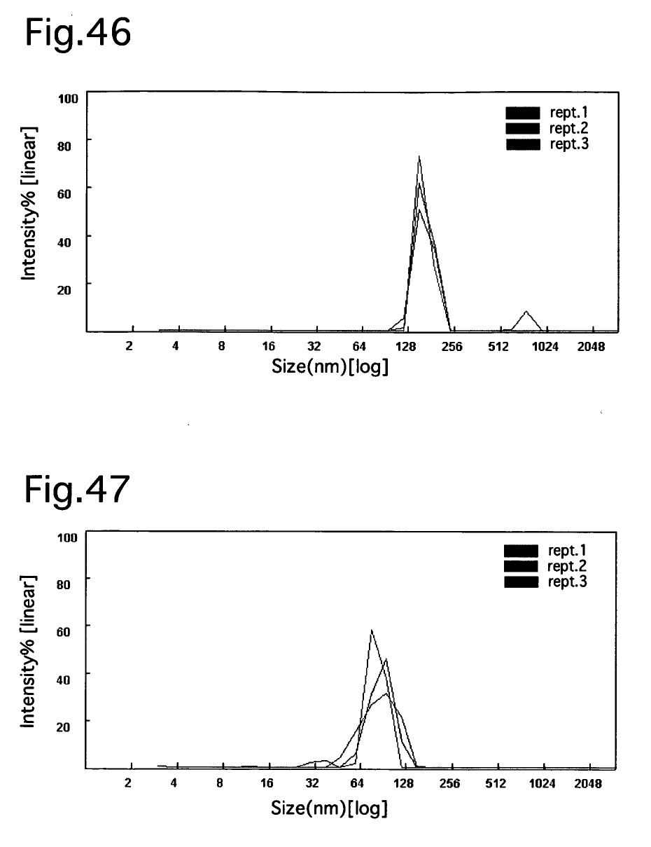

FIG. 46 is a graph of a particle size distribution of the HA nanoparticles dispersed in IPA by dynamic scattering method. The average particle size of the HA nanoparticle in the dispersion liquid was 127 nm.

FIG. 47 is a graph of a particle size distribution of the HA nanoparticles dispersed in DMSO by dynamic scattering method. The average particle size of the HA nanoparticle in the dispersion liquid was 86 nm.

FIG. 48 is a graph of a particle size distribution of the HA nanoparticles dispersed in DMF by dynamic scattering method. The average particle size of the HA nanoparticle in the dispersion liquid was 59 nm.

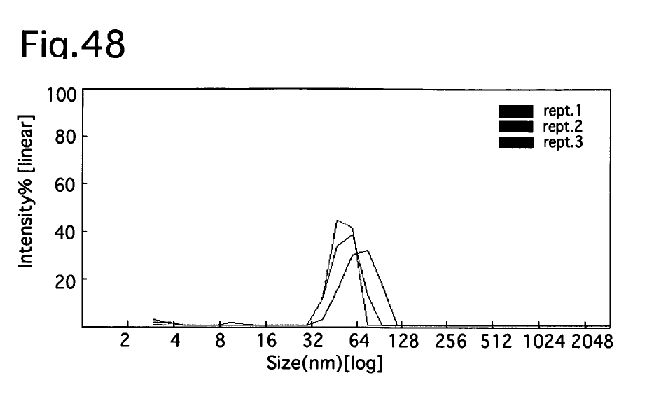

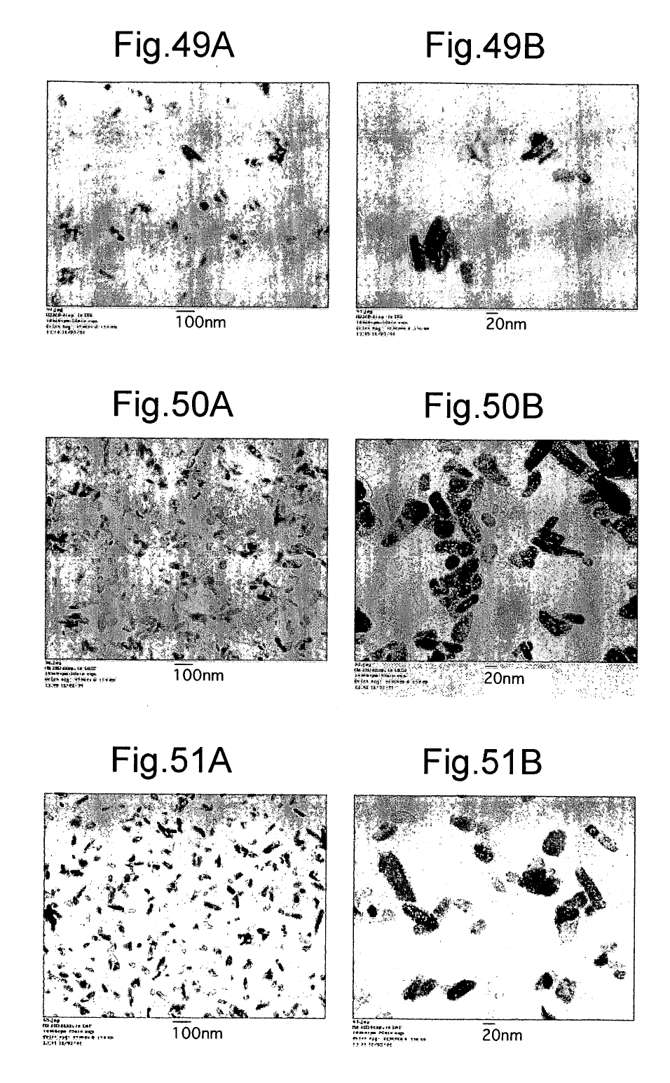

FIG. 49A is a TEM photograph at a magnification of 15,000 times, in which the HA particles were dispersed in IPA. FIG. 49B is a TEM photograph at a magnification of 50,000 times.

FIG. 50A is a TEM photograph at a magnification of 15,000 times, in which the HA nanoparticles were dispersed in DMSO. FIG. 50B is a TEM photograph at a magnification of 50,000 times.

FIG. 51A is a TEM photograph at a magnification of 15,000 times, in which the HA nanoparticles were dispersed in DMF. FIG. 51B is a TEM photograph at a magnification of 50000 times.

As shown in FIGS. 49 through 51, HA nanoparticles exist in each medium under the condition that the each particle is dispersed completely in each medium, and are in a state where more than one particle are aggregated in a row at the direction of c-axis.

Table 1 shows the results of calculating an average particle size of HA nanoparticles based on the TEM photographs (FIG. 49 to FIG. 51) of dispersion liquids of HA nanoparticles. The methods of calculating the average particle size were conducted in two kinds of methods, namely, one method being that each particle which constitutes an aggregate (the aggregate-constituting particle) is considered as one particle (i.e. Calculating method A), and other method being that the aggregated particle (aggregation mass) is considered as one particle (i.e. Calculating method B). Calculating method A shows substantially the same values with substantially no difference of the particle size of HA nanoparticles among each dispersion medium. On the other hand, Calculating method B shows differences among each dispersion medium. Namely, the aggregation degree of HA nanoparticles is different depending on the kind of dispersion medium.

TABLE 1

| | |
|---|---|
| CALCULATION | CALCULATION |
| METHOD A | METHOD B |

| | Long Axis | Short Axis | Long Axis | Short Axis |
|---|---|---|---|---|
| | (nm) | (nm) | (nm) | (nm) |
| IPA | 69.3 | 29.9 | 127.3 | 76.5 |
| DMSO | 63.2 | 28.0 | 86.5 | 47.4 |
| DMF | 60.1 | 20.5 | 58.6 | 42.4 |

### REFERENCE EXAMPLE 1

Influence of the balls made from zirconia in the dry milling is shown as follows. The heat treated HA particles and sintered zirconia balls are contained in a pot in a ball milling device and dry milling (treatment time: 1 hour) was performed. After dry milling, the inner wall of the pot was observed under a state of no vapor-deposit and low vacuum (Hitachi, Ltd, S-3000N). Finely divided particles were determined about the chemical composition by using an energy dispersing type X-ray Analyzer (Horibaseisakusho, Ltd., EMAXENERGY).

FIG. 33 is a SEM image of the inner wall of the pot after that the thermally treated HA particles of Example 5 were placed in a dry mill pot and dry milling conducted without balls provided in the pot. The inner wall of the pot had a smooth surface structure just as before the dry milling treatment. The magnification was 900 times.

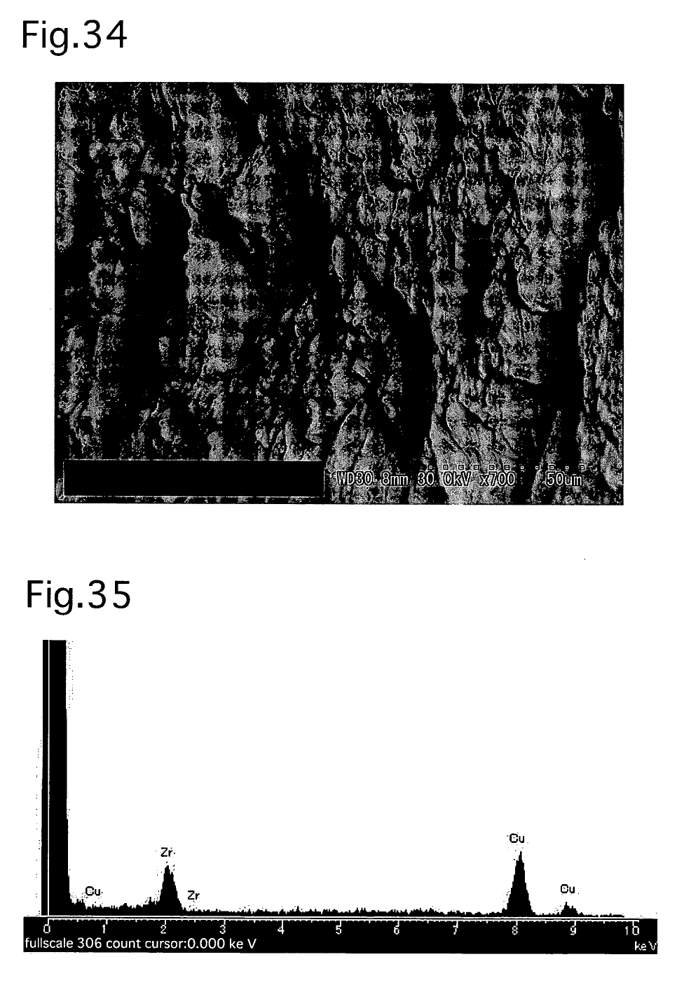

FIG. 34 is a SEM image of the inner wall of the pot after the thermally treated HA particles and the sintered zirconia balls were placed in a pot. A dry mill treatment was conducted in this Reference example. The inner wall of the pot was grinded away significantly, and produced an uneven surface. The magnification was 700 times.

FIG. 35 shows the analysis result of the chemical composition by EDX of finely divided particles which are obtained with dry milling under containing the sintered zirconia balls. In these finely divided particles, a larger amount of zirconia (Zr), which is derived from the inner wall of the pot and the sintered zirconia balls, was detected than HA(Ca.P), and the finely divided particles contained a lot of contaminants.

### REFERENCE EXAMPLE 2

The dispersion liquid of HA nanoparticles of this reference Example was prepared in a similar manner to Example 4, expect that the ball milling for 15 hours in the presence of 1.0 g of isopropanol was performed (wet milling), and the shape and aspect ratio of the particles were analyzed.

The results of analysis of the shape and aspect ratio of the thermally treated HA particles and the HA nanoparticles prepared in this Reference example are shown as follows.

(C) Particle Shape and Aspect Ratio

FIG. 43 is a transmission electron microphotograph of HA nanoparticles of this example. Calculating from this TEM photograph, the HA nanoparticles which had the average particle size of about 100 nm and were spherical or in a shape of rounded polygon were not observed, and the HA nanoparticles of about 20 nm and the aspect ratio of 1:2 and more were confirmed. The magnification was 80,000 times.

### COMPARISON EXAMPLE 1

An aqueous solution of phosphate and an aqueous solution of calcium salt were mixed to prepare a slurry containing hydroxyapatite. From the slurry, hydroxyapatite crystallites were obtained.

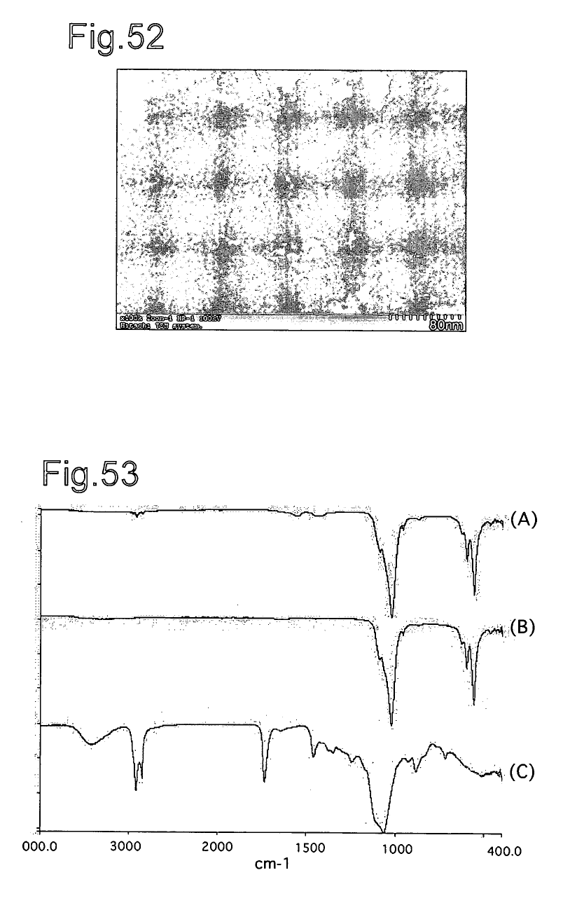

FIG. 52 is a TEM photograph of hydroxyapatite slurry. The slurry was observed in this photograph, and the shape and aspect ratio of the crystallites were searched. The magnification was 100,000 times.

The average particle size of the hydroxyapatite crystallite prepared in Comparison example 1 was about 85 nm. Additionally, the mean aspect ratio was 8.0.

### COMPARISON EXAMPLE 2

For the preparation of hydroxyapatite nanoparticles by an emulsion method, octane and polyoxyethylene sorbitan monolaurate were used for an oil layer and a non-ionic surface active agent, respectively. 100 ml of oil layer and 10 ml of surface active agent were mixed at room temperature, and then 10 ml of 0.2M ammonium phosphate water solution was added. After stirring thoroughly, 10 ml of 0.33 M calcium nitrite water solution was added, and the mixture was reacted at a reactive temperature of 40° C. for 18 hours. The reaction was completed, then the mixture was centrifuged at 4100×g for 5 minutes to remove the oil layer constituents and the surface active agent. The oil-surface active agent layer of the supernatant was removed. Thereafter the replacing operation with ethanol was repeated three times to perform a washing treatment. After washing, the nanoparticles were dried to provide a sample.

The samples were supplied to an infrared spectrophotometer, and the chemical species of the samples obtained in Comparison Example 1 and 2 were analyzed. The infrared spectrophotometer ‘Spectrum One’ manufactured by Perkin Elmer, Ltd., was used as an infrared spectrophotometer.

In FIG. 53, (A) shows an infrared absorption spectrum of hydroxyapatite nanoparticles prepared by an emulsion method in Comparison Example 2, (B) shows an infrared absorption spectrum of hydroxyapatite crystallites prepared by a wet method in Comparison Example 1, and (C) shows an infrared spectra of each surface active agent.

The spectrum (FIG. 53, (A)) of hydroxyapatite nanoparticles prepared in Comparison Example 2 and the spectrum (FIG. 53, (B)) of hydroxyapatite crystallite prepared in Comparison Example 1 showed an absorption at 1000 to 1100 cm⁻¹, which is attributed to a phosphate group. Additionally, they showed a large amount of absorption in the vicinity of 400 to 600 cm⁻¹, and such absorption is a characteristic absorption peak of hydroxyapatite. Furthermore, there was a small peak in the vicinity of 2900 cm⁻¹ in the spectrum of (A) in FIG. 53.

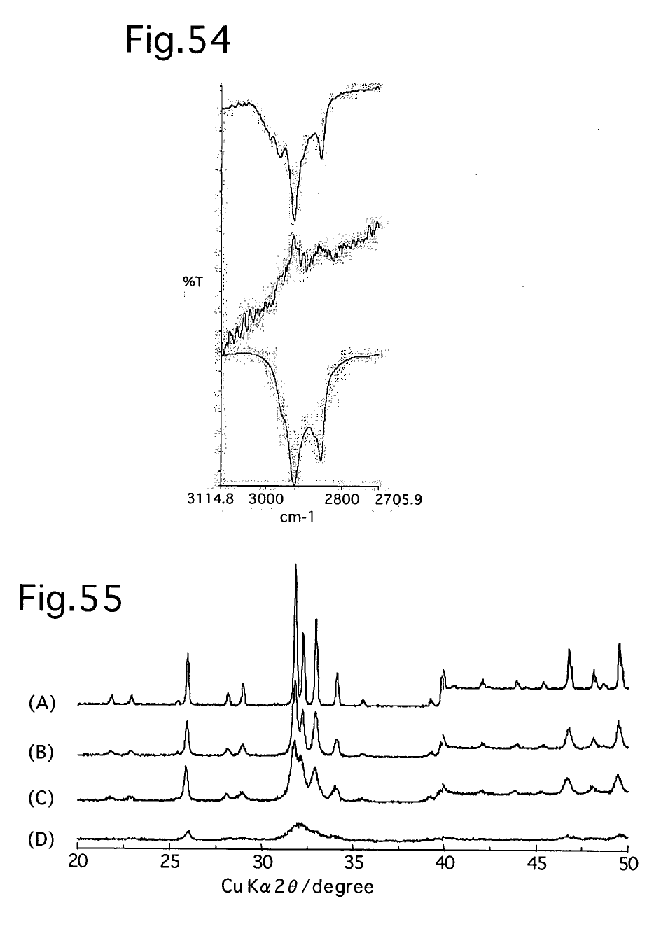

FIG. 54 is a graph of an enlarged portion of the area in the vicinity of 2900 cm⁻¹ in (A), (B) and (C) of FIG. 53. As shown in FIG. 54, the absorption nearing the vicinity of 2900 cm⁻¹ corresponds to the absorption peak of a surface active agent (see (C) of FIG. 53). Accordingly, it can be understood that a surface active agent remains in the hydroxyapatite nanoparticles prepared in Comparison Example 2.

In FIG. 55, (A) through (C) show each X-ray diffraction spectrum of HA nanoparticles prepared in Example 1 through Example 3, and (D) shows an X-ray diffraction spectrum of HA nanoparticles prepared in Comparison Example 2. The hydroxyapatite nanoparticles prepared in Comparison Example 2 shows a representative pattern of X-ray diffraction spectrums of non-sintered apatite compounds, and the crystallite diameter was about 6 nm on calculating from the maximum peak. As shown in FIG. 55, the spectrum pattern of hydroxyapatite nanoparticles in Comparison Example 2 had much noise and a broad band in comparison to the spectra pattern of HA nanoparticles prepared in Examples 1 through 3. Therefore, it can be understood that the crystallite diameter is smaller and the crystallinity is very low compared to the crystallite diameter of HA nanoparticles prepared in Examples 1 through 3.

Although the invention has been described with reference to particular means, materials and embodiments, it is to be understood that the invention is not limited to the particulars disclosed and extends to all equivalents within the scope of the claims.

1. Calcium phosphate compound nanoparticles comprising:
crystalline nanoparticles, wherein upon sustaining a thermal history, a crystallite diameter thereof at a maximum peak in an X-ray diffraction spectrum is in a range of 10 nm to 100 nm, and a shape of said crystalline nanoparticles is one of spherical and oval-spherical.

2. The calcium phosphate compound nanoparticles according to claim 1, wherein a mean aspect ratio of said calcium phosphate compound nanoparticles is in a range of 1.0 to 2.5.

3. The calcium phosphate compound nanoparticles according to claim 1, wherein said thermal history consists of heat-treatment at a temperature of 400° C. to 1050° C.

4. A dispersion liquid of the calcium phosphate compound nanoparticles according to claim 1, wherein said calcium phosphate compound nanoparticles are dispersed in an organic solvent.

5. The dispersion liquid of the calcium phosphate compound nanoparticles according to claim 4, wherein said organic solvent comprises a polar organic solvent.

6. The dispersion liquid of the calcium phosphate compound nanoparticles according to claim 5, wherein said polar organic solvent comprises at least one of alcohol, ether, acetonitrile, tetrahydrofuran, and dimethylsulphoxide.

7. A production method of a dispersion liquid of calcium phosphate compound nanoparticles, comprising: a thermal treating process of heating a calcium phosphate compound;
a crushing process of dispersing said calcium phosphate compound particles obtained in said thermal treating process in an organic solvent and crushing said calcium phosphate compound particles; and
a separating process of centrifuging the dispersion liquid of calcium phosphate compound obtained in said crushing process and collecting a supernatant liquid thereof.

8. The production method of a dispersion liquid of calcium phosphate compound nanoparticles according to claim 7, comprising a milling process, wherein said calcium phosphate compound particles obtained in said thermal treating process are ball milled.

9. The production method of a dispersion liquid of calcium phosphate compound nanoparticles according to claim 8, wherein the ball milling is performed in a ball mill without using balls.

10. The production method of a dispersion liquid of calcium phosphate compound nanoparticles according to claim 8, wherein said ball milling is performed under dry conditions.

11. The production method of a dispersion liquid of calcium phosphate compound nanoparticles according to claim 9, wherein said ball milling is performed under dry conditions.

12. The production method of a dispersion liquid of calcium phosphate compound nanoparticles according to claim 7, wherein the calcium phosphate compound comprises hydroxyapatite as a starting material, and wherein said hydroxyapatite is granulated by spray-drying.

13. The production method of a dispersion liquid of calcium phosphate compound nanoparticles according to claim 7, wherein said thermal treatment process is performed at a temperature of 400° C. to 1050° C.

14. The production method of a dispersion liquid of calcium phosphate compound nanoparticles according to claim 7, wherein said organic solvent comprises a polar organic solvent.

15. The production method of a dispersion liquid of calcium phosphate compound nanoparticles according to claim 14, wherein said polar organic solvent comprises at least one of alcohol, ether, acetonitrile, tetrahydrofuran, and dimethylsulphoxide.

16. The production method of a dispersion liquid of calcium phosphate compound nanoparticles according to claim 7, wherein said crushing process is performed by ultrasonication.

17. A production method of calcium phosphate compound nanoparticles, comprising:
evaporating said organic solvent in the supernatant liquid obtained in said separating process according to claim 7.
